(19) United States
(12) Patent Application Publication
(10) Pub. No.: US 2021/0294079 A1
(43) Pub. Date: Sep. 23, 2021

(54) Image Camera Lens

(71) Applicant: ZHEJIANG SUNNY OPTICS CO.,LTD., Jiangyin, Jiangsu (CN)

(72) Inventors: Qi CHEN, Ningbo, Zhejiang (CN); Bo SONG, Ningbo, Zhejiang (CN); Kaiyuan ZHANG, Ningbo, Zhejiang (CN); Lin HUANG, Ningbo, Zhejiang (CN); Liefeng ZHAO, Ningbo, Zhejiang (CN)

(21) Appl. No.: 17/257,587

(22) PCT Filed: Jul. 10, 2019
(86) PCT No.: PCT/CN2019/095357

§ 371 Date: Jan. 4, 2021

(30) Foreign Application Priority Data
Aug. 31, 2018 (CN) 201811011387.5

(51) Int. Cl. G02B 13/00; G02B 9/60; G02B 27/00

(52) U.S. Cl. CPC G02B 13/0045; G02B 27/005; G02B 9/60

(57) ABSTRACT

An image camera lens (100) includes an optical lens group (101) and a lens tube (102) configured to accommodate the optical lens group (101). The optical lens group (101) sequentially includes, from an object side to an image side along an optical axis, a first lens (E1) and at least one subsequent lens with refractive power. A lens semi-diameter LM of the first lens (E1), a maximum effective semi-diameter DT11 of an object-side surface (S1) of the first lens (E1) and a distance SAG11 from an intersection point of the object-side surface (S1) of the first lens (E1) and the optical axis to a vertex of the maximum effective semi-diameter of the object-side surface (S1) of the first lens (E1) meet (LM−DT11)/SAG11<1.0.

### CROSS-REFERENCE TO RELATED APPLICATIONS

The present application claims priority to Chinese Patent Application No. 201811011387.5, filed to the National Intellectual Property Administration, PRC (CNIPA) on Aug. 31, 2018, the disclosure of which is hereby incorporated by reference in its entirety.

### TECHNICAL FIELD

The disclosure relates to the field of optical camera lenses, and more particularly to an optical lens group including five lenses and an image camera lens configured to accommodate the optical lens group and having a relatively small end portion size.

### BACKGROUND

In recent years, along with the rapid development of portable electronic, products with photographic functions, requirements on the performance of image camera lenses that portable electronic products carry have become increasingly strict. On one hand, due to the continuous improvement of semiconductor technologies such as Charge-Coupled Device (CCD) and Complementary Metal-Oxide Semiconductor (CMOS) image sensor, the number of image elements gradually increases and higher requirements are made to both miniaturization and high imaging quality of a matched image camera lens. On the other hand, along with extensive pursuits of consumers for electronic products with photographic functions and ultra-high screen-to-body ratios, an image camera lens mounted above a screen is expected to be capable of meeting higher requirements on imaging quality and smaller sizes. However, a present lens tube carrying a lens group usually has a relatively large end portion size and may occupy a relatively large screen space when being mounted above a screen as a front camera, so a requirement on an ultra-high screen-to-body ratio of a portable electronic product such as a present mainstream full-screen phone may not be met.

### SUMMARY

Some embodiments of the disclosure provides an optical lens group and an image camera lens configured to accommodate an optical camera lens and having a relatively small end portion size, which may at least overcome or partially overcome at least one of the foregoing shortcomings in the related art.

In an implementation mode, the disclosure provides an image camera lens, which includes an optical lens group and a lens tube configured to accommodate the optical lens group, wherein the optical lens group sequentially includes, from an object side to an image side along an optical axis, a first lens and at least one subsequent lens with refractive power, and a lens semi-diameter LM of the first lens, a maximum effective semi-diameter DT11 of an object-side surface of the first lens and a distance SAG11 from an intersection point of the object-side surface of the first lens and the optical axis to a vertex of the maximum effective semi-diameter of the object-side surface of the first lens on the optical axis may meet (LM−DT11)/SAG11<1.0.

In an implementation mode, the maximum effective semi-diameter DT11 of the object-side surface of the first lens and a front end semi-diameter D of the lens tube may meet DT11/D>0.63.

In an implementation mode, Sensize is a diagonal size of a photosensitive chip on an imaging surface of the image camera lens, the lens semi-diameter LM of the first lens, the maximum effective semi-diameter DT11 of the object-side surface of the first lens and Sensize may meet (LM−DT11)/Sensize<0.30.

In an implementation mode, a supporting size LQ between the lens tube and the first lens may meet LQ≤0.13 mm.

In an implementation mode, a front end wall thickness H of the lens tube may meet H≤0.25 mm.

In an implementation mode, the first lens may have positive refractive power, and the object-side surface thereof may be a convex surface.

In an implementation mode, the at least one subsequent lens includes a second lens arranged between the first lens and the image side, the second Jens may have negative refractive power, an object-side surface thereof may be a convex surface, and an image-side surface may be a concave surface.

In an implementation mode, a semi-diameter difference LA between the first lens and the second lens may meet 0.1 mm≤LA≤0.5 mm.

In an implementation mode, a ladderlike spacing ring is arranged between the first lens and the second lens.

In an implementation mode, the at least one subsequent lens further includes a third lens arranged between the second lens and the image side, and an image-side surface of the third lens may be a convex surface.

In an implementation mode, a center thickness CT3 of the third lens on the optical axis and an edge thickness ET3 of the third lens may meet 1<CT3/ET3<2.

In an implementation mode, the at least one subsequent lens further includes a fourth lens and a fifth lens sequentially arranged between the third lens and the image side from the object side to the image side along the optical axis, the fourth lens may have positive refractive power, an image-side surface thereof may be a convex surface, and the fifth lens may have negative refractive power.

In an implementation mode, an effective focal length f1 of the first lens, an effective focal length f2 of the second lens and an effective focal length f5 of the fifth lens may meet −4.2<(f2+f5)/f1<−2.

In an implementation mode, the maximum effective semi-diameter DT11 of the object-side surface of the first lens and a maximum effective semi-diameter DT52 of an image-side surface of the fifth lens may meet 1 mm<DT52−DT11<2 mm.

In an implementation mode, a center thickness CT4 of the fourth lens on the optical axis and a thickness NT4 of a thinnest part of the fourth lens may meet 1<CT4/NT4<3.

In an implementation mode, a thickness MT5 of a thickest part of the fifth lens and a center thickness CT5 of the fifth lens on the optical axis may meet 1<MT5/CT5<5.

In an implementation mode, a maximum field of view (FOV) of the image camera lens may meet FOV<85°.

In an implementation mode, ImgH is a diagonal length of an effective pixel region on the imaging surface of the image camera lens, a distance TTL from the object-side surface of the first lens to the imaging surface of the image camera lens on the optical axis and ImgH may meet TTL/ImgH≤1.4.

According to the disclosure, a front end structure of the image camera lens is reasonably controlled to ensure that the image camera lens has a relatively small end portion size, may be used as a front camera of a portable electronic product and may meet a requirement on an ultra-high screen-to-body ratio of the portable electronic product. Furthermore, the refractive power, surface type and thickness of each lens in the image camera lens, on-axis spaces between adjacent lenses and the like are reasonably configured to achieve at least one beneficial effect of ultra-small thickness, large image surface, high imaging quality and the like of the image camera lens.

### BRIEF DESCRIPTION OF THE DRAWINGS

Detailed descriptions are made to unrestrictive implementation modes below in combination with the drawings to make the other characteristics, purposes and advantages of the disclosure more apparent. In the drawings:

FIG. 1 shows a structure diagram of an optical lens group according to embodiment 1 of the disclosure;

FIG. 2A to FIG. 2D show a longitudinal aberration curve, an astigmatism curve, a distortion curve and a lateral color curve of an optical lens group according to embodiment 1 respectively;

FIG. 3 shows a structure diagram of an optical lens group according to embodiment 2 of the disclosure;

FIG. 4A to FIG. 4D show a longitudinal aberration curve, an astigmatism curve, a distortion curve and a lateral color curve of an optical lens, group according to embodiment 2 respectively;

FIG. 5 shows a structure diagram of an optical lens group according to embodiment 3 of the disclosure;

FIG. 6A to FIG. 6D show a longitudinal aberration curve, an astigmatism curve, a distortion curve and a lateral color curve of an optical lens, group according to embodiment 3 respectively;

FIG. 7 shows a structure diagram of an optical lens group according to embodiment 4 of the disclosure;

FIG. 8A to FIG. 8D show a longitudinal aberration curve, an astigmatism curve, a distortion curve and a lateral color curve of an optical lens group according to embodiment 4 respectively;

FIG. 9 shows a structure diagram of an optical lens group according to embodiment 5 of the disclosure;

FIG. 10A to FIG. 10D show a longitudinal aberration curve, an astigmatism curve, a distortion curve and a lateral color curve of an optical lens group according to embodiment 5 respectively;

FIG. 11 shows a structure diagram of an optical lens group according to embodiment 6 of the disclosure;

FIG. 12A to FIG. 12D show a longitudinal aberration curve, an astigmatism curve, a distortion curve and a lateral color curve of an optical lens group according to embodiment 6 respectively;

FIG. 13 shows a structure diagram of an optical lens group according to embodiment 7 of the disclosure;

FIG. 14A to FIG. 14D show a longitudinal aberration curve, an astigmatism curve, a distortion curve and a lateral color curve of an optical lens group according to embodiment 7 respectively;

FIG. 15 shows a structure diagram of an optical lens group according to embodiment 8 of the disclosure;

FIG. 16A to FIG. 16D show a longitudinal aberration curve, an astigmatism curve, a distortion curve and a lateral color curve of an optical lens group according to embodiment 8 respectively;

FIG. 17 shows a structure diagram of an optical lens group according to embodiment 9 of the disclosure;

FIG. 18A to FIG. 18D show a longitudinal aberration curve, an astigmatism curve, a distortion curve and a lateral color curve of an optical lens group according to embodiment 9 respectively;

FIG. 19 shows a section view of an image camera lens according to the disclosure;

FIG. 20 schematically shows an optical effective region and optical noneffective regions of a first lens of an image camera lens according to the disclosure;

FIG. 21 schematically shows a front end semi-diameter D of a lens tube of an image camera lens according to the disclosure;

FIG. 22 schematically shows a semi-diameter difference LA between a first lens and second lens of an image camera lens according to the disclosure;

FIG. 23 schematically shows a supporting size LQ between a lens tube and first lens of an image camera lens according to the disclosure; and

FIG. 24 schematically shows a front end wall thickness H of a lens tube of an image camera lens according to the disclosure.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It is to be noted that, in the specification, expressions like first, second and third are adopted not to represent any limit to characteristics but only to distinguish one characteristic from another characteristic. Therefore, a first lens discussed below may also be called a second lens or a third lens under the condition of not departing from the teachings of the disclosure.

In the drawings, the thickness, size and shape of the lens have been slightly exaggerated for ease illustration. In particular, a spherical shape or an aspherical shape shown in the drawings is shown by some embodiments. That is, the spherical shape or the aspherical shape is not limited to the spherical shape or the aspherical shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if the lens surface is a concave surface and a position of the concave surface is not defined, it indicates that the lens surface is a concave surface at least in the paraxial region. A surface of each lens closest to an object-side is called an object-side surface of the lens, and a surface of each lens closest to an imaging surface is called an image-side surface of the lens.

It is also to be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail. The features, principles and other aspects of the disclosure will be described below in detail.

An aspect of the disclosure relates to an optical lens group with a large image surface and high imaging quality. The optical lens group according to an exemplary implementation mode of the disclosure may include, for example, five lenses with refractive power, i.e., a first lens, a second lens, a third lens, a fourth lens and a fifth lens. The five lenses are sequentially arranged from an object side to an image side along an optical axis, and there may be air spaces between adjacent lenses.

In the exemplary implementation mode, the first lens may have positive refractive power, and an object-side surface thereof may be a convex surface; the second lens may have negative refractive power, an object-side surface thereof may be a convex surface, and an image-side surface may be a concave surface; the third lens may have positive refractive power or negative refractive power, and an image-side surface thereof may be a convex surface; the fourth lens may have positive refractive power, and an image-side surface thereof may be a convex surface; and the fifth lens may have negative refractive power. Optionally, an image-side surface of the fifth lens may be a concave surface. The optical lens group is applied to a lens tube structure with a small end portion size. Positive and negative refractive power distribution and bending direction of each lens may be reasonably controlled to effectively balance a low-order aberration of an optical system.

In the exemplary implementation mode, the optical lens group of the disclosure may meet a conditional expression TTL/ImgH≤1.4, where TTL is a distance from the object-side surface of the first lens to an imaging surface of the optical lens group (i.e., an imaging surface of an image camera lens) on the optical axis, and ImgH is a half of a diagonal length of an effective pixel region on the imaging surface of the optical lens group. More specifically, TTL and ImgH may further meet 1.28≤TTL/ImgH≤1.37. A ratio of TTL to ImgH may be controlled to ensure that the optical lens group meets a requirement on an ultra-small thickness.

In the exemplary implementation mode, the optical lens group of the disclosure may meet a conditional expression 1 mm<DT52−DT11<2 mm, where DT52 is a maximum effective semi-diameter of the image-side surface of the fifth lens, and DT11 is a maximum effective semi-diameter of the object-side surface of the first lens. More specifically, DT52 and DT11 may further meet 1.24 mm≤DT52−DT11≤1.74 mm. The conditional expression 1 mm<DT52−DT11<2 mm is met, so that a maximum effective semi-diameter of the lens group may be effectively controlled to further help to reduce a size of a lens tube.

In the exemplary implementation mode, the optical lens group of the disclosure may meet a conditional expression 1<CT3/ET3<2, where CT3 is a center thickness of the third lens on the optical axis, and ET3 is an edge thickness of the third lens. More specifically, CT3 and ET3 may further meet 1.13≤CT3/ET3≤1.78. Controlling the edge thickness of the third lens and the center thickness of the third lens on the optical axis is favorable for eliminating a chromatic aberration.

In the exemplary implementation mode, the optical lens group of the disclosure may meet a conditional expression −4.2<(f2+f5)/f1<−2, where f1 is an effective focal length of the first lens, f2 is an effective focal length of the second lens, and f5 is an effective focal length of the fifth lens. More specifically, f1, f2 and f5 may further meet −4.15≤(f2+f5)/f1≤−2.44. The effective focal lengths of the first lens, the second lens and the fifth lens may be reasonably controlled to ensure reasonable deflection and convergence of light after entering the lens group, effectively eliminate a spherical aberration, astigmatism and a distortion and simultaneously reduce the sensitivity of the camera lens.

In the exemplary implementation mode, the optical lens group of the disclosure may meet a conditional expression 1<CT4/NT4<3, where CT4 is a center thickness of the fourth lens on the optical axis, and NT4 is a thickness of a thinnest part (parallel to a direction of the optical axis) of the fourth lens. More specifically, CT4 and NT4 may further meet 1.0<CT4/NT4≤2.5, for example, 1.09≤CT4/NT4≤2.33. In addition, the optical lens group of the disclosure may also meet a conditional expression 1<MT5/CT5<5, where MT5 is a thickness, of a thickest part (parallel to the direction of the optical axis) of the fifth lens, and CT5 is a center thickness of the fifth lens on the optical axis. More specifically, MT5 and CT5 may further meet 1.5<MT5/CT5<5, for example, 1.84≤MT5/CT5≤4.89. A ratio of the center thickness and minimum thickness of the fourth lens and a ratio of the maximum thickness and center thickness of the fifth lens may be reasonably controlled to effectively control a curvature of field of the optical system and simultaneously make the lens high in manufacturability and easy to manufacture.

In the exemplary implementation mode, the optical lens group of the disclosure may meet a conditional expression FOV<85°, where FOV is a maximum field of view of the optical lens group (i.e., a maximum field of view of the image camera lens). More specifically, FOV may further meet 75°≤FOV≤85°, for example, 80.1°≤FOV≤82.6°. A full field of view may be reasonably controlled to effectively control an imaging range of the optical lens group (or the image camera lens).

In the exemplary implementation mode, the optical lens group may further include a diaphragm to improve the imaging quality of the camera lens. Optionally, the diaphragm may be arranged between the object side and the first lens. Optionally, the optical lens group may further include an optical filter configured to correct a chromatic aberration and/or protective glass configured to protect a photosensitive element on the imaging surface.

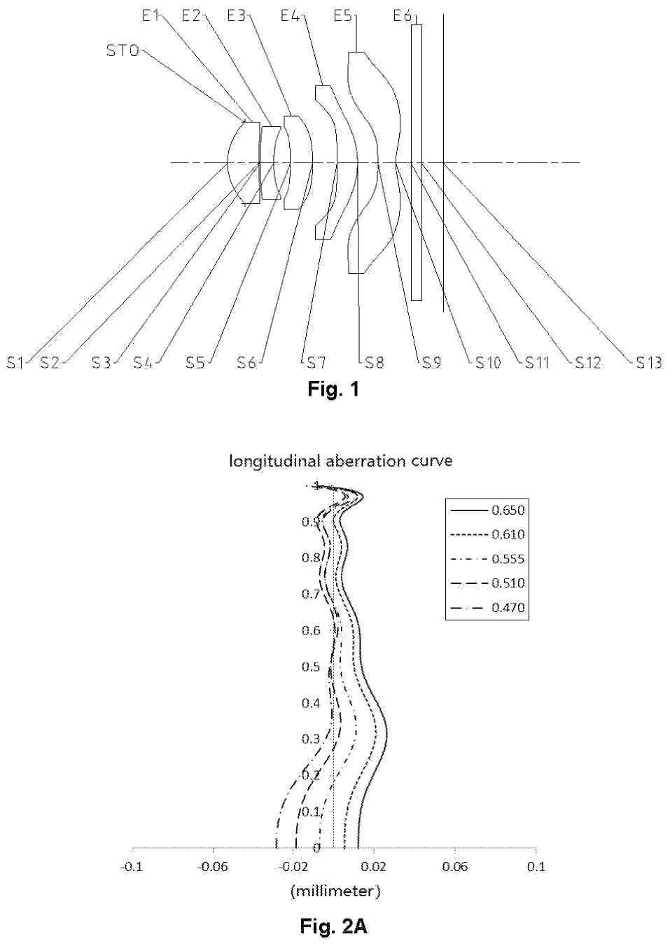

Specific embodiments applied to the optical lens group of the implementation mode will further be described below with reference to FIG. 1 to FIG. 18D.

### Embodiment 1

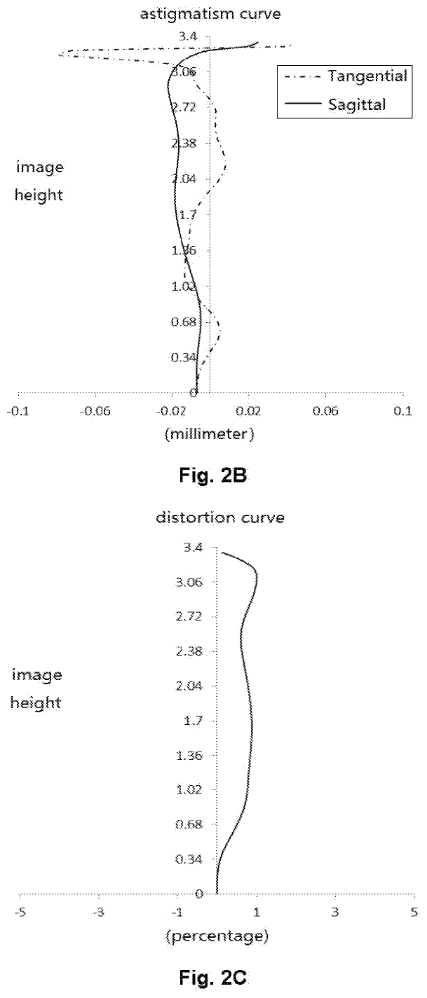

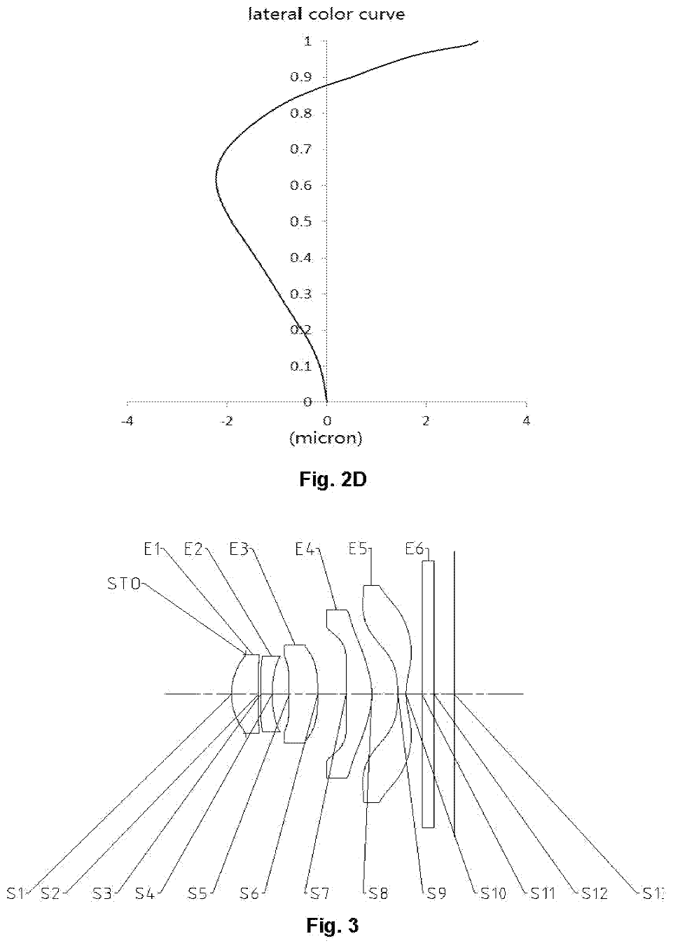

An optical lens group according to embodiment 1 of the disclosure will be described below with reference to FIG. 1 to FIG. 2D. FIG. 1 is a structure diagram of an optical lens group according to embodiment 1 of the disclosure.

As shown in FIG. 1, the optical lens group according to an exemplary implementation mode of the disclosure sequentially includes, from an object side to an image side along an optical axis, a diaphragm STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has positive refractive power, an object-side surface S5 thereof is a concave surface, and an image-side surface S6 is a convex surface. The fourth lens E4 has positive refractive power, an object-side surface S7 thereof is a concave surface, and an image-side surface S8 is a convex surface. The filth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface 313.

Table 1 shows a surface type, curvature radius, thickness, material and cone coefficient of each lens of the optical lens group according to embodiment 1. Units of the curvature radius and the thickness are millimeter (mm).

TABLE 1

| | | | | Material | | |
|---|---|---|---|---|---|---|
| Surface | | Curvature | | Refractive | | Cone |
| number | Surface type | radius | Thickness | index | Abbe number | coefficient |
| OBJ | Spherical | Infinite | Infinite | | | |
| STO | Spherical | Infinite | −0.3315 | | | |
| S1 | Aspherical | 1.3571 | 0.6319 | 1.55 | 56.1 | −0.1279 |
| S2 | Aspherical | 5.0462 | 0.0255 | | | −21.9705 |
| S3 | Aspherical | 5.2048 | 0.2744 | 1.67 | 20.4 | 34.8856 |
| S4 | Aspherical | 2.7549 | 0.3395 | | | 7.3205 |
| S5 | Asplierical | −6.7323 | 0.4427 | 1.55 | 56.1 | −82.7463 |
| S6 | Aspherical | −4.8956 | 0.4892 | | | −86.7251 |
| S7 | Aspherical | −17.2097 | 0.4145 | 1.55 | 56.1 | 13.7586 |
| S8 | Aspherical | −2.0549 | 0.4060 | | | −1.3623 |
| S9 | Aspherical | −30.7179 | 0.3625 | 1.54 | 55.7 | 80.5573 |
| S10 | Aspherical | 1.4145 | 0.3056 | | | −10.7435 |
| S11 | Spherical | Infinite | 0.2100 | 1.52 | 64.2 | |
| S12 | Spherical | Infinite | 0.4400 | | | |
| S13 | Spherical | Infinite | | | | |

From Table 1, it can be seen that both the object-side surface and image-side surface of any lens in the first lens E1 to the fifth lens E5 are aspherical surfaces. In the embodiment, the surface type x of each aspherical lens may be defined by use of, but not limited to, the following aspherical surface formula:

$$x = \frac{{ch}^{2}}{1 + \sqrt{1 - ( k + 1 ) {c}^{2} {h}^{2}}} + \sum {Aih}^{i} \qquad ( 1 )$$

wherein, x is the distance vector height from a vertex of the aspherical surface when the aspherical surface is at a height of along the optical axis direction; c is a paraxial curvature of the aspherical surface, c=1/R (namely, the paraxial curvature c is a reciprocal of the curvature radius R in Table 1); k is the cone coefficient (given in Table 1); and Ai is an ith-order correction coefficient of the aspherical surface. Table 2 shows higher-order coefficients A₄, A₆, A₈, A₁₀, A₁₂, A₁₄, A₁₆, A₁₈ and A₂₀ that can be used for each of aspherical mirror surfaces S1-S10 in embodiment 1.

TABLE 2

| Surface | | | | | | | | | |
|---|---|---|---|---|---|---|---|---|---|
| number | A4 | A6 | A8 | A10 | A12 | A14 | A16 | A18 | A20 |
| S1 | 2.3107E−02 | −3.4493E−01 | 3.3414E+00 | −1.7158E+01 | 5.1744E+01 | −9.4510E+01 | 1.0271E+02 | −6.1069E+01 | 1.5269E+01 |
| S2 | −1.9204E−01 | −8.6960E−01 | 1.1207E+01 | −5.670E+01 | 1.7483E+02 | −3.4232E+02 | 4.1197E+02 | −2.7736E+02 | 7.9815E+01 |
| S3 | −2.4701E−01 | −3.4690E−01 | 6.7944E+00 | −3.3195E+01 | 9.5914E+01 | −1.7545E+02 | 1.9568E+02 | −1.1994E+02 | 3.0198E+01 |
| S4 | −4.5844E−02 | 2.6557E−01 | −1.8842E+00 | 1.5583E+01 | −7.4402E+01 | 2.0924E+02 | −3.4510E+02 | 3.0996E+02 | −1.1710E+02 |
| S5 | −2.2806E−01 | 6.2763E−01 | −6.0693E+00 | 3.3736E+01 | −1.1757E+02 | 2.5801E+02 | −3.4732E+02 | 2.6221E+02 | −8.4736E+01 |
| S6 | −2.1045E−01 | 2.1575E−02 | 9.5179E−02 | −1.9081E−01 | −5.2979E−01 | 2.3361E+00 | −3.4570E+00 | 2.3926E+00 | −6.3916E−01 |
| S7 | 5.9555E−03 | −1.9359E−01 | 2.5073E−01 | −2.0894E−01 | 5.2405E−02 | 5.3184E−02 | −5.4724E−02 | 2.1661E−02 | −3.3210E−03 |
| S8 | 4.3829E−02 | −1.6766E−01 | 2.8397E−01 | −2.7716E−01 | 1.6830E−01 | −6.0522E−02 | 1.1655E−02 | −9.2053E−04 | −8.9544E−07 |
| S9 | −5.2146E−01 | 4.7028E−01 | −2.5600E−01 | 1.0455E−01 | −3.1595E−02 | 6.5906E−03 | −8.7824E−04 | 6.6700E−05 | −2.1887E−06 |
| S10 | −2.2794E−01 | 1.8427E−01 | −1.0326E−01 | 3.8930E−02 | −9.7960E−03 | 1.5614E−03 | −1.4325E−04 | 6.2552E−06 | −7.0241E−08 |

Table 3 shows effective focal lengths f1 to f5 of the lenses in embodiment 1, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 3

| f1 (mm) | f2 (mm) | f3 (mm) | f4 (mm) | f5 (mm) | f (mm) | TTL (mm) | ImgH (mm) | FOV (°) |
|---|---|---|---|---|---|---|---|---|
| 3.21 | −9.20 | 30.29 | 4.23 | −2.51 | 3.81 | 4.34 | 3.38 | 82.0 |

FIG. 2A shows a longitudinal aberration curve of the optical lens group according to embodiment 1 to represent deviations of a convergence focal point after light of different wavelengths passes through the lens. FIG. 2B shows an astigmatism curve of the optical lens group according to embodiment 1 to represent a meridian image surface curvature and a sagittal image surface curvature. FIG. 2C shows a distortion curve of the optical lens group according to embodiment 1 to represent distortion values corresponding to different image heights. FIG. 2D shows a lateral color curve of the optical lens group according to embodiment 1 to represent deviations of different image heights on the imaging surface after the light passes through the lens. According to FIG. 2A to FIG. 2D, it can be seen that high imaging quality of the optical lens group provided in embodiment 1 may be achieved.

### Embodiment 2

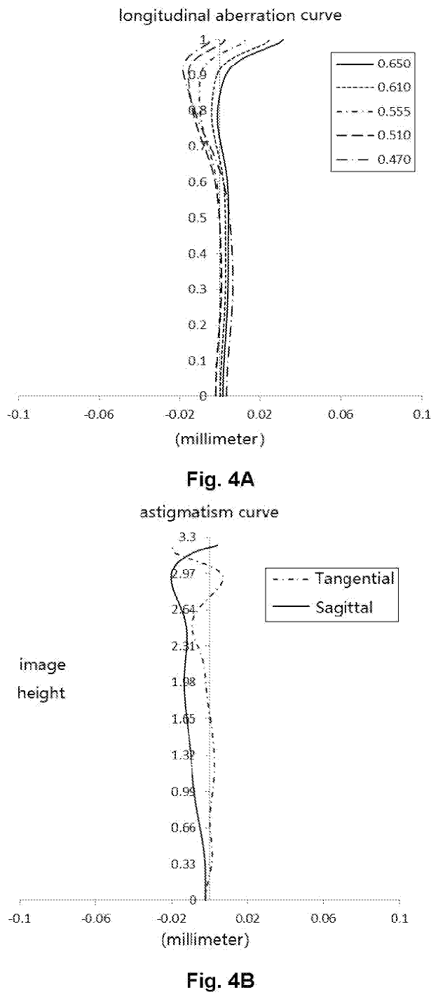

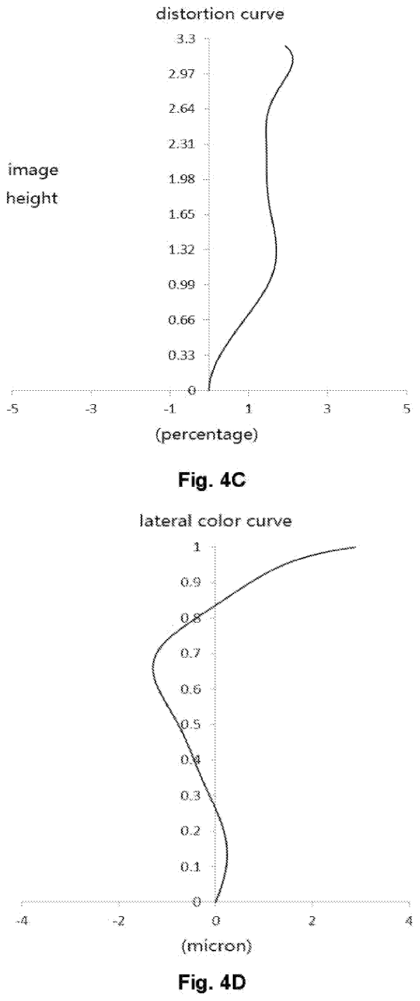

An optical lens group according to embodiment 2 of the disclosure will be described below with reference to FIG. 3 to FIG. 4D. In the embodiment and the following embodiments, part of descriptions similar to those about embodiment 1 are omitted for simplicity. FIG. 3 is a structure diagram of an optical lens group according to embodiment 2 of the disclosure.

As shown in FIG. 3, the optical lens group according to an exemplary implementation mode of the disclosure sequentially includes, from an object side to an image side along an optical axis, a diaphragm. STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is, a convex surface. The second lens E2 has negative refractive power, an object-side surface S3 thereof is a convex surface, and an image-side surface S4 is a concave surface. The third lens E3 has positive refractive power, an object-side surface S5 thereof is a concave surface, and an image-side surface S6 is a convex surface. The fourth lens E4 has positive refractive power, an object-side surface S7 thereof is a concave surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 4 shows, a surface type, curvature radius, thickness, material and cone coefficient of each lens of the optical lens group according to embodiment 2. Units of the curvature radius and the thickness are millimeter (mm). Table 5 shows high-order coefficients applied to each aspherical mirror surface in embodiment 2. A surface type of each aspherical surface may be defined by formula (1) given in embodiment 1. Table 6 shows effective focal lengths f1 to f5 of the lenses in embodiment 2, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 4

| | | | | Material | | |
|---|---|---|---|---|---|---|
| Surface | | Curvature | | Refractive | | Cone |
| number | Surface type | radius | Thickness | index | Abbe number | coefficient |
| OBJ | Spherical | Infinite | Infinite | | | |
| STO | Spherical | Infinite | −0.2812 | | | |
| S1 | Aspherical | 1.5602 | 0.5354 | 1.55 | 56.1 | 0.2875 |
| S2 | Aspherical | −67.2925 | 0.0435 | | | −99.0000 |
| S3 | Aspherical | 18.0826 | 0.2300 | 1.67 | 20.4 | −16.3720 |
| S4 | Aspherical | 2.6960 | 0.3403 | | | −0.4712 |
| S5 | Aspherical | −46.5934 | 0.5675 | 1.55 | 56.1 | −99.0000 |
| S6 | Aspherical | −7.2135 | 0.5646 | | | −13.8365 |
| S7 | Aspherical | −502.8228 | 0.5111 | 1.55 | 56.1 | 99.0000 |
| S8 | Aspherical | −1.6462 | 0.5141 | | | −0.9550 |
| S9 | Aspherical | −3.9135 | 0.1600 | 1.54 | 55.7 | 0.3807 |
| S10 | Aspherical | 1.5687 | 0.3186 | | | −0.9427 |
| S11 | Spherical | Infinite | 0.2450 | 1.52 | 64.2 | |
| S12 | Spherical | Infinite | 0.3999 | | | |
| S13 | Spherical | Infinite | | | | |

TABLE 5

| Surface | | | | | | | | | |
|---|---|---|---|---|---|---|---|---|---|
| number | A4 | A6 | A8 | A10 | A12 | A14 | A16 | A18 | A20 |
| S1 | −1.3993E−02 | 1.1389E−01 | −7.5121E−01 | 2.8970E+00 | −6.8925E+00 | 1.0212E+01 | −9.2064E+00 | 4.6424E+00 | −1.0047E+00 |
| S2 | −2.5265E−02 | 2.1677E−01 | −1.7180E−01 | −5.3062E−01 | 1.3495E−01 | 6.3984E+00 | −1.6912E+01 | 1.7816E+01 | −7.0234E+00 |
| S3 | −7.9936E−02 | 2.5040E−01 | 9.5146E−01 | −8.7680E+00 | 3.1292E+01 | −6.3178E+01 | 7.5143E+01 | −4.8790E+01 | 1.3225E+01 |
| S4 | −7.3624E−02 | 2.7165E−01 | −7.6840E−01 | 3.2252E+00 | −1.1916E+01 | 2.9584E+01 | −4.3890E+01 | 3.5728E+01 | −1.2265E+01 |
| S5 | −1.3387E−01 | −1.5745E−01 | 9.3478E−01 | −3.9112E+00 | 9.1646E+00 | −1.1840E+01 | 6.4512E+00 | 1.4303E+00 | −2.0308E+00 |
| S6 | −1.0714E−01 | −4.2747E−03 | −4.1662E−01 | 1.7518E+00 | −3.9606E+00 | 5.3664E+00 | −4.3381E+00 | 1.9338E+00 | −3.5977E−01 |
| S7 | 6.1858E−02 | −1.2656E−01 | 1.2055E−01 | −1.9916E−01 | 2.3989E−01 | −1.7800E−01 | 7.4568E−02 | −1.5632E−02 | 1.2379E−03 |
| S8 | 2.4239E−01 | −2.7092E−01 | 2.4418E−01 | −1.9219E−01 | 1.1673E−01 | −4.6416E−02 | 1.1036E−02 | −1.4177E−03 | 7.5484E−05 |
| S9 | −1.0953E−01 | −1.5824E−01 | 2.2988E−01 | −1.1934E−01 | 3.4184E−02 | −5.8979E−03 | 6.0767E−04 | −3.4051E−05 | 7.7791E−07 |
| S10 | −3.5523E−01 | 2.1950E−01 | −1.0886E−01 | 4.1490E−02 | −1.1388E−02 | 2.0797E−03 | −2.3428E−04 | 1.4613E−05 | −3.8492E−07 |

TABLE 6

| f1 (mm) | f2 (mm) | f3 (mm) | f4 (mm) | f5 (mm) | f (mm) | TTL (mm) | ImgH (mm) | FOV (°) |
|---|---|---|---|---|---|---|---|---|
| 2.80 | −4.78 | 15.56 | 3.02 | −2.07 | 3.72 | 4.43 | 3.23 | 80.9 |

FIG. 4A shows a longitudinal aberration curve of the optical lens group according to embodiment 2 to represent deviations of a convergence focal point after light of different wavelengths passes through the lens. FIG. 4B shows an astigmatism curve of the optical lens group according to embodiment 2 to represent a meridian image surface curvature and a sagittal image surface curvature. FIG. 4C shows a distortion curve of the optical lens group according to embodiment 2 to represent distortion values corresponding to different image heights. FIG. 4D shows a lateral color curve of the optical lens group according to embodiment 2 to represent deviations of different image heights on the imaging surface after the light passes through the lens. According to FIG. 4A to FIG. 4D, it can be seen that high imaging quality of the optical lens group provided in embodiment 2 may be achieved.

### Embodiment 3

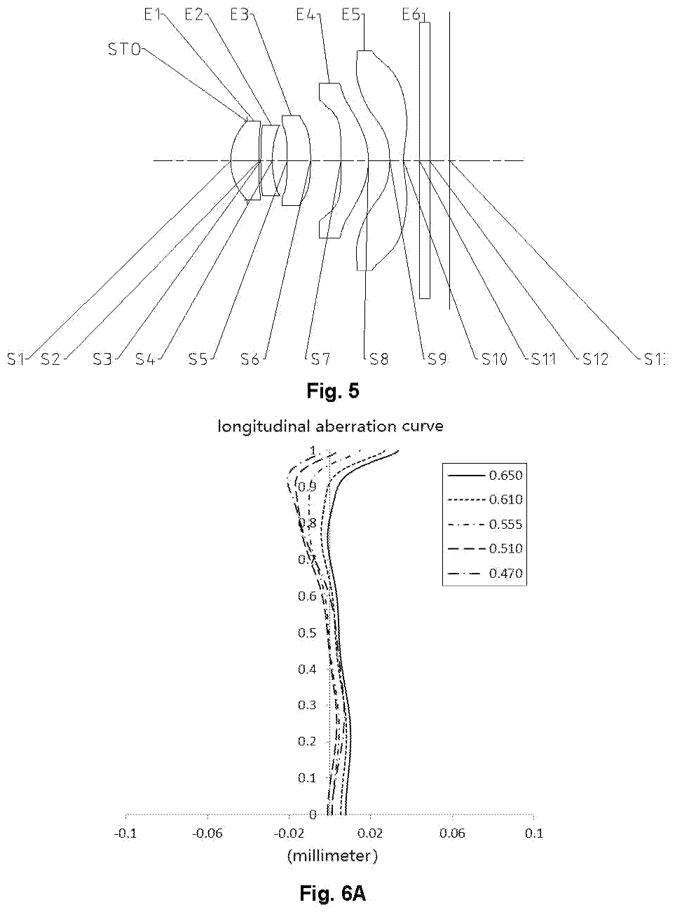

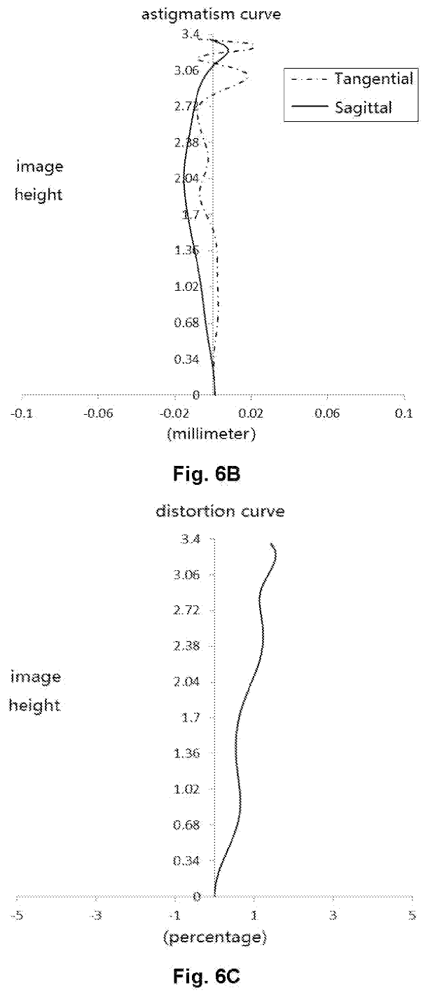

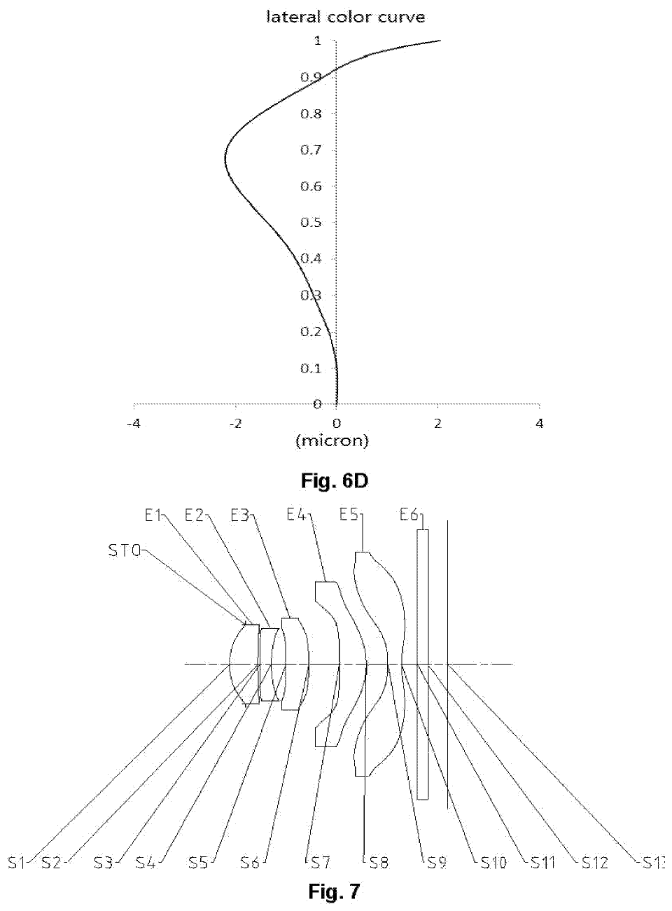

An optical lens group according to embodiment 3 of the disclosure will be described below with reference to FIG. 5 to FIG. 6D. FIG. 5 is a structure diagram of an optical lens group according to embodiment 3 of the disclosure.

As shown in FIG. 5, the optical lens group according to an exemplary implementation mode of the disclosure sequentially includes, from an object side to an image side along an optical axis, a diaphragm. STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has positive refractive power, an object-side surface S5 thereof is a concave surface, and an image-side surface S6 is a convex surface. The fourth lens E4 has positive refractive power, an object-side surface S7 thereof is a concave surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 7 shows a surface type, curvature radius, thickness, material and cone coefficient of each lens of the optical lens group according to embodiment 3. Units of the curvature radius and the thickness are millimeter (mm). Table 8 shows high-order coefficients applied to each aspherical mirror surface in embodiment 3. A surface type of each aspherical surface may be defined by formula (1) given in embodiment 1. Table 9 shows effective focal lengths f1 to f5 of the lenses in embodiment 3, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 7

| | | | | Material | | |
|---|---|---|---|---|---|---|
| Surface | | Curvature | | Refractive | | Cone |
| number | Surface type | radius | Thickness | index | Abbe number | coefficient |
| OBJ | Spherical | Infinite | Infinite | | | |
| STO | Spherical | Infinite | −0.3169 | | | |
| S1 | Aspherical | 1.4442 | 0.5611 | 1.55 | 56.1 | 0.0180 |
| S2 | Aspherical | 19.4580 | 0.0337 | | | −99.0000 |
| S3 | Aspherical | 8.4034 | 0.2300 | 1.67 | 20.4 | 13.1662 |
| S4 | Aspherical | 2.3930 | 0.2953 | | | 0.0479 |
| S5 | Aspherical | −60.3233 | 0.4642 | 1.55 | 56.1 | 99.0000 |
| S6 | Aspherical | −6.9374 | 0.6051 | | | −3.5416 |
| S7 | Aspherical | −55.8209 | 0.5450 | 1.55 | 56.1 | −95.0943 |
| S8 | Aspherical | −1.6468 | 0.4236 | | | −1.1397 |
| S9 | Aspherical | −2.5531 | 0.2700 | 1.54 | 55.7 | 0.0959 |
| S10 | Aspherical | 1.9976 | 0.3177 | | | −1.0421 |
| S11 | Spherical | Infinite | 0.2100 | 1.52 | 64.2 | |
| S12 | Spherical | Infinite | 0.3944 | | | |
| S13 | Spherical | Infinite | | | | |

TABLE 8

| Surface | | | | | | | | | |
|---|---|---|---|---|---|---|---|---|---|
| number | A4 | A6 | A8 | A10 | A12 | A14 | A16 | A18 | A20 |
| S1 | −2.9206E−03 | 1.0623E−01 | −5.8937E−01 | 2.0949E+00 | −4.5217E+00 | 6.0712E+00 | −4.9495E+00 | 2.2781E+00 | −4.5854E+01 |
| S2 | −1.4945E−01 | 7.4838E−01 | −1.1755E+00 | −1.5657E+00 | 1.2074E+01 | −2.5631E+01 | 2.5739E+01 | −1.0329E+01 | 0.0000E+00 |
| S3 | −2.2402E−01 | 8.4036E−01 | −4.9108E−01 | −7.5931E+00 | 3.6544E+01 | −8.3870E+01 | 1.0779E+02 | −7.3335E+01 | 2.0187E+01 |
| S4 | −1.1418E−01 | 4.1550E−01 | −9.5658E−01 | 2.7572E+00 | −1.0153E+01 | 3.0588E+01 | −5.6350E+01 | 5.6253E+01 | −2.3039E+01 |
| S5 | −1.7930E−01 | 1.9353E−01 | −2.4335E+00 | 1.4723E+01 | −5.6547E+01 | 1.3558E+02 | −1.9753E+02 | 1.5962E+02 | −5.3945E+01 |
| S6 | −13830E−01 | 1.2306E−01 | −1.2771E+00 | 5.4231E+00 | −1.4016E+01 | 2.2491E+01 | −2.1810E+01 | 1.1699E+01 | −2.6321E+00 |
| S7 | −7.1314E−04 | −1.8447E−01 | 4.2381E−01 | −1.0215E+00 | 1.5738E+00 | −1.4940E+00 | 8.2759E−01 | −2.4124E−01 | 2.8423E−02 |
| S8 | 1.2416E−01 | −2.0712E−01 | 1.9508E−01 | −1.0876E−01 | 4.0329E−02 | −9.2830E−03 | 1.0050E−03 | 1.3788E−05 | −9.2119E−06 |
| S9 | −2.0113E−01 | 1.5742E−02 | 1.9771E−01 | −1.6722E−01 | 6.7447E−02 | −1.5752E−02 | 2.1860E−03 | −1.6834E−04 | 5.5731E−06 |
| S10 | −3.5755E−01 | 2.8392E−01 | −1.6598E−01 | 7.1300E−02 | −2.2078E−02 | 4.7066E−03 | −6.4793E−04 | 5.1381E−05 | −1.7674E−06 |

TABLE 9

| f1 (mm) | f2 (mm) | f3 (mm) | f4 (mm) | f5 (mm) | f (mm) | TTL (mm) | ImgH (mm) | FOV (°) |
|---|---|---|---|---|---|---|---|---|
| 2.83 | −5.09 | 14.32 | 3.10 | −2.01 | 3.72 | 4.35 | 3.36 | 82.6 |

FIG. 6A shows a longitudinal aberration curve of the optical lens group according to embodiment 3 to represent deviations of a convergence focal point after light of different wavelengths passes through the lens. FIG. 6B shows an astigmatism curve of the optical lens group according to embodiment 3 to represent a meridian image surface curvature and a sagittal image surface curvature. FIG. 6C shows a distortion curve of the optical lens group according to embodiment 3 to represent distortion values corresponding to different image heights. FIG. 6D shows a lateral color curve of the optical lens group according to embodiment 3 to represent deviations of different image heights on the imaging surface after the light passes through the lens. According to FIG. 6A to FIG. 6D, it can be seen that high imaging quality of the optical lens group provided in embodiment 3 may be achieved.

### Embodiment 4

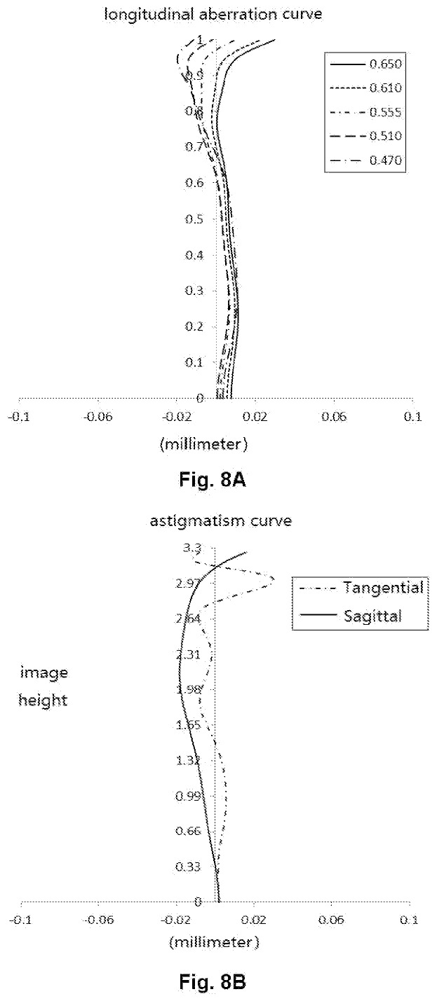

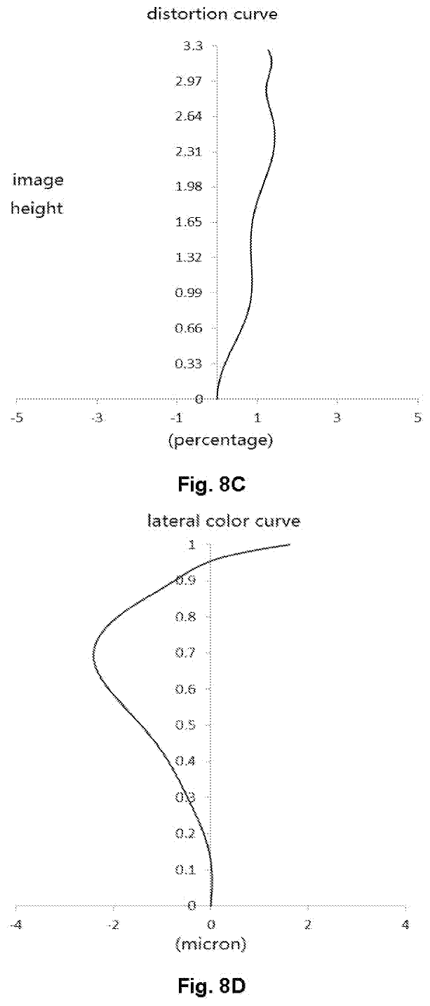

An optical lens group according to embodiment 4 of the disclosure will be described below with reference to FIG. 7 to FIG. 8D. FIG. 7 is a structure diagram of an optical lens group according to embodiment 4 of the disclosure.

As shown in FIG. 7, the optical lens group according to an exemplary implementation mode of the disclosure sequentially includes, from an object side to an image side along an optical axis, a diaphragm STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has positive refractive power, an object-side surface S5 thereof is a convex surface, and an image-side surface S6 is a convex surface. The fourth lens E4 has positive refractive power, an object-side surface S7 thereof is a concave surface, and an image-side surface S8 is a convex surface. The fifth lens E5 has negative refractive power, an object-side surface S9 thereof is a concave surface, and an image-side surface S10 is a concave surface. The optical filter E6 has an object-side surface Sib and an image-side surface S12. Light from an object sequentially penetrates through each of the surfaces S1 to S12 and is finally imaged on the imaging surface S13.

Table 10 shows a surface type, curvature radius, thickness, material and cone coefficient of each lens of the optical lens group according to embodiment 4. Units of the curvature radius and the thickness are millimeter (mm). Table 11 shows high-order coefficients applied to each aspherical mirror surface in embodiment 4. A surface type of each aspherical surface may be defined by formula (1) given in embodiment 1. Table 12 shows effective focal lengths f1 to f5 of the lenses in embodiment 4, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 10

| | | | | Material | | |
|---|---|---|---|---|---|---|
| Surface | | Curvature | | Refractive | | Cone |
| number | Surface type | radius | Thickness | index | Abbe number | coefficient |
| OBJ | Spherical | Infinite | Infinite | | | |
| STO | Spherical | Infinite | −0.3247 | | | |
| S1 | Aspherical | 1.4489 | 0.5680 | 1.55 | 56.1 | 0.0203 |
| S2 | Aspherical | 19.3468 | 0.0374 | | | 75.0010 |
| S3 | Aspherical | 10.4678 | 0.2300 | 1.67 | 20.4 | 29.0130 |
| S4 | Aspherical | 2.4748 | 0.2865 | | | −0.0067 |
| S5 | Aspherical | 66.4999 | 0.4598 | 1.55 | 56.1 | −70.9940 |
| S6 | Aspherical | −7.4566 | 0.6090 | | | 0.0410 |
| S7 | Aspherical | −33.0996 | 0.5363 | 1.55 | 56 1 | 43.5233 |
| S8 | Aspherical | −1.6297 | 0.4287 | | | −1.1796 |
| S9 | Aspherical | −2.5827 | 0.2700 | 1.54 | 55.7 | 0.1069 |
| S10 | Aspherical | 2.0527 | 0.3180 | | | −1.0306 |
| S11 | Spherical | Infinite | 0.2100 | 1.52 | 64.2 | |
| S12 | Spherical | Infinite | 0.3963 | | | |
| S13 | Spherical | Infinite | | | | |

TABLE 11

| Surface | | | | | | | | | |
|---|---|---|---|---|---|---|---|---|---|
| number | A4 | A6 | A8 | A10 | A12 | A14 | A16 | A18 | A20 |
| S1 | −6.1217E−03 | 1.3488E−01 | −7.7740E−01 | 2.8480E+00 | −6.4393E+00 | 9.1627E+00 | −7.9775E+00 | 3.9048E+00 | −8.1757E−01 |
| S2 | −1.5019E−01 | 7.6670E−01 | −2.0009E+00 | 4.8826E+00 | −1.3069E+01 | 3.1327E+01 | −4.9970E+01 | 4.4441E+01 | −1.5556E+01 |
| S3 | −2.2318E−01 | 8.4919E−01 | −9.4932E−01 | −3.6028E−00 | 1.9814E+01 | −4.3734E+01 | 5.1680E+01 | −3.0849E+01 | 6.8198E+00 |
| S4 | −1.1926E−01 | 4.7022E−01 | −1.2338E+00 | 3.9181E+00 | −1.3316E+01 | 3.5341E+01 | −5.9132E+01 | 5.4885E+01 | −2.1242E+01 |
| S5 | −1.7688E−01 | 2.0506E−01 | −2.43858+00 | 1.4497E+01 | −5.4421E+01 | 1.2715E+02 | −1.8000E+02 | 1.4098E+02 | −4.6167E+01 |
| S6 | −1.3326E−01 | 1.2518E−01 | −1.3025E+00 | 5.5065E+00 | −1.4063E+01 | 2.2205E+01 | −2.1137E+01 | 1.1111E+01 | −2.4466E+00 |
| S7 | −4.4251E−03 | −1.56455−01 | 2.9076E−01 | −6.4151E−01 | 9.6355E−01 | −9.1806E−01 | 5.1426E−01 | −1.5119E−01 | 1.7892E−02 |
| S8 | 1.2503E−01 | −2.1383E−01 | 2.1476E−01 | −1.3533E−01 | 6.3587E−02 | −2.1755E−02 | 4.8292E−03 | −6.0086E−04 | 3.1097E−05 |
| S9 | −1.6644E−01 | −4.2319E−02 | 2.3883E−01 | −1.8457E−01 | 7.2274E−02 | −1.6644E−02 | 2.2902E−03 | −1.7516E−04 | 5.7570E−06 |
| S10 | −3.2479E−01 | 2.4034E−01 | −1.3526E−01 | 5.7748E−02 | −1.8206E−02 | 3.9973E−03 | −5.6839E−04 | 4.6487E−05 | −1.6433E−06 |

TABLE 12

| f1 (mm) | f2 (mm) | f3 (mm) | f4 (mm) | f5 (mm) | f (mm) | TTL (mm) | ImgH (mm) | FOV (°) |
|---|---|---|---|---|---|---|---|---|
| 2.84 | −4.92 | 12.31 | 3.17 | −2.05 | 3.72 | 4.35 | 3.26 | 80.9 |

FIG. 8A shows a longitudinal aberration curve of the optical lens group according to embodiment 4 to represent deviations of a convergence focal point after light of different wavelengths passes through the lens. FIG. 8B shows an astigmatism curve of the optical lens group according to embodiment 4 to represent a meridian image surface curvature and a sagittal image surface curvature. FIG. 8C shows a distortion curve of the optical lens group according to embodiment 4 to represent distortion values corresponding to different image heights. FIG. 8D shows a lateral color curve of the optical lens group according to embodiment 4 to represent deviations of different image heights on the imaging surface after the light passes through the lens. According to FIG. 8A to FIG. 8D, it can be seen that high imaging quality of the optical lens group provided in embodiment 4 may be achieved.

### Embodiment 5

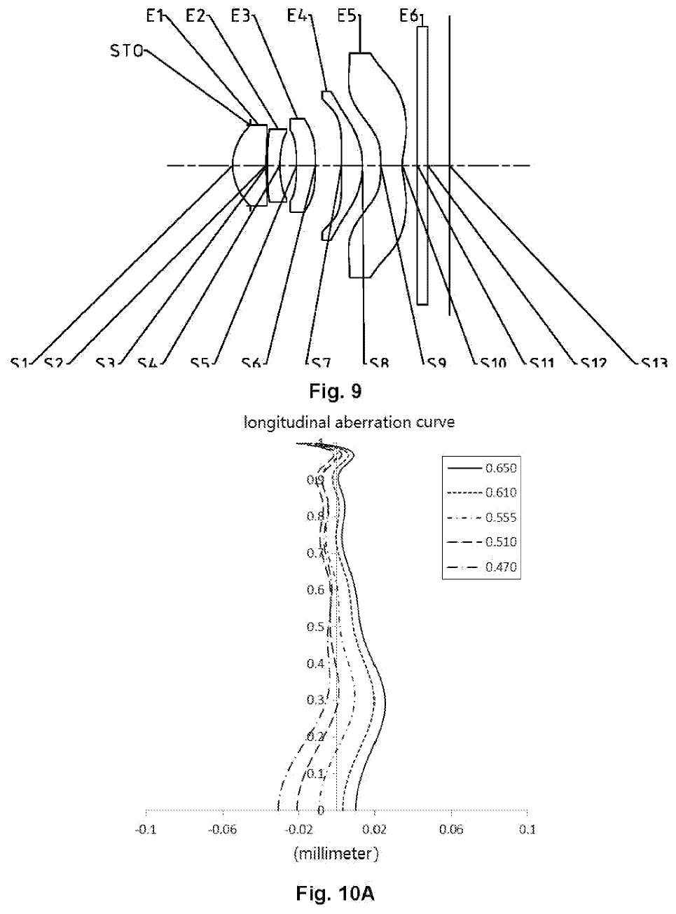

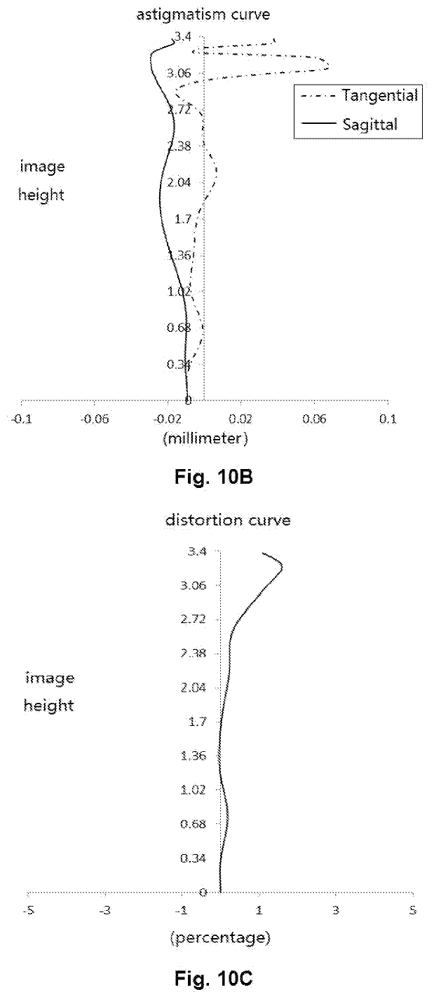

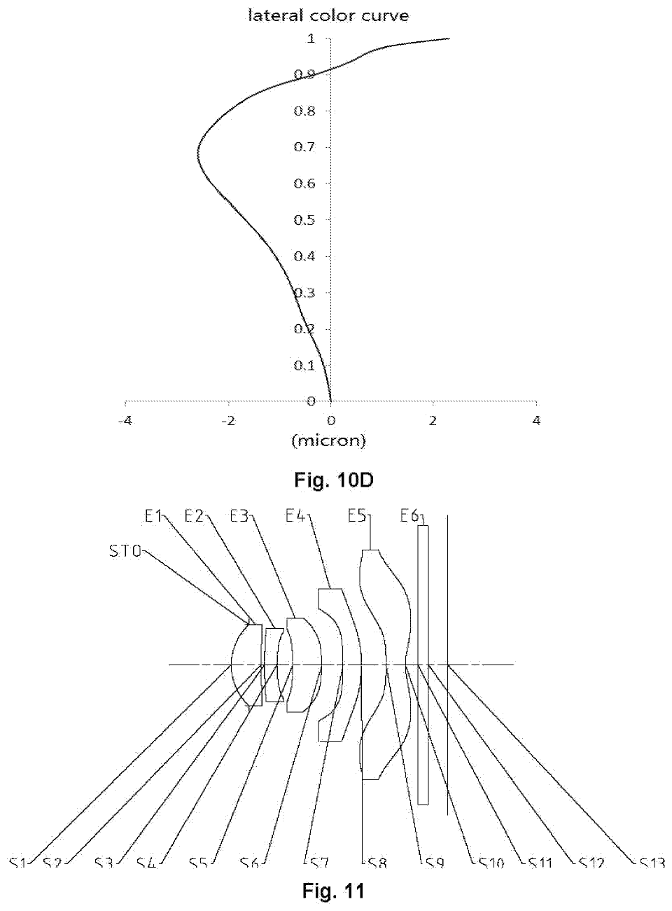

An optical lens group according to embodiment 5 of the disclosure will be described below with reference to FIG. 9 to FIG. 10D. FIG. 9 is a structure diagram of an optical lens group according to embodiment 5 of the disclosure.

As shown in FIG. 9, the optical lens group according to an exemplary implementation mode of the disclosure sequentially includes, from an object side to an image side along an optical axis, a diaphragm. STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has positive refractive power, an object-side surface S5 thereof is a concave surface, and an image-side surface S6 is a convex surface. The fourth lens E4 has positive refractive power, an object-side surface S7 thereof is a convex surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 13 shows a surface type, curvature radius, thickness, material and cone coefficient of each lens of the optical lens group according to embodiment 5. Units of the curvature radius and the thickness are millimeter (mm). Table 14 shows high-order coefficients applied to each aspherical mirror surface in embodiment 5. A surface type of each aspherical surface may be defined by formula (1) given in embodiment 1. Table 15 shows effective focal lengths f1 to f5 of the lenses in embodiment 5, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 13

| | | | | Material | | |
|---|---|---|---|---|---|---|
| Surface | | Curvature | | Refractive | | Cone |
| number | Surface type | radius | Thickness | index | Abbe number | coefficient |
| OBJ | Spherical | Infinite | Infinite | | | |
| STO | Spherical | Infinite | −0.3317 | | | |
| S1 | Aspherical | 1.3558 | 0.6669 | 1.55 | 56.1 | −0.1316 |
| S2 | Aspherical | 5.0396 | 0.0267 | | | −25.2218 |
| S3 | Aspherical | 5.2050 | 0.2512 | 1.67 | 20.4 | 34.7059 |
| S4 | Aspherical | 2.7762 | 0.3350 | | | 7.3459 |
| S5 | Aspherical | −7.2264 | 0.3788 | 1.55 | 56.1 | −80.8285 |
| S6 | Aspherical | −6.7762 | 0.5210 | | | −99.0000 |
| S7 | Aspherical | 80.7901 | 0.4200 | 1.55, | 56.1 | −99.0000 |
| S8 | Aspherical | −2.1293 | 0.3692 | | | −0.6272 |
| S9 | Aspherical | −13.640.3 | 0.4300 | 1.54 | 55.7 | 28.8549 |
| S10 | Aspherical | 1.4807 | 0.2994 | | | −11.5852 |
| S11 | Spherical | Infinite | 0.2100 | 1.52 | 64.2 | |
| S12 | Spherical | Infinite | 0.4359 | | | |
| S13 | Spherical | Infinite | | | | |

TABLE 14

| Surface | | | | | | | | | |
|---|---|---|---|---|---|---|---|---|---|
| number | A4 | A6 | A8 | A10 | A12 | A14 | A16 | A18 | A20 |
| S1 | 9.0648E−03 | −1.1980E−01 | 1.5153E+00 | −8.6876E+00 | 2.7910E+01 | −5.3154E+01 | 5.9524E+01 | −3.6223E+01 | 9.2288E+00 |
| S2 | −2.1620E−01 | −4.4493E−01 | 7.5638E+00 | −3.7596E+01 | 1.1180E+02 | −2.1329E+02 | 2.5340E+02 | −1.7021E+02 | 4.9254E+01 |
| S3 | −2.6508E−01 | −1.2551E−01 | 5.1212E+00 | −2.4335E+01 | 6.5468E+01 | −1.1134E+02 | 1.1638E+02 | −6.7245E+01 | 1.5839E+01 |
| S4 | −3.8654E−02 | −6.4092E−02 | 2.2392E+00 | −1.2203E+01 | 3.9066E+01 | −7.8563E+01 | 9.7484E+01 | −6.7641E+01 | 2.0121E+01 |
| S5 | −2.0708E−01 | 2.2868E−01 | −2.1413E+00 | 1.0562E+01 | −3.1976E+01 | 5.8636E+01 | −6.2859E+01 | 3.5406E+01 | −7.4987E+00 |
| S6 | −1.3725E−01 | −2.2594E−01 | 1.3385E+00 | −4.5465E+00 | 9.4875E+00 | −1.2322E+01 | 9.6672E+00 | 4.1300E+00 | 7.2994E−01 |
| S7 | −6.8989E−03 | −1.2380E−01 | 1.3901E−01 | −5.5315E−02 | −7.5198E−02 | 1.1240E−01 | −6.6698E−02 | 2.0069E−02 | −2.4734E−03 |
| S8 | −6.6436E−02 | 8.4124E−02 | −1.9151E−01 | 3.6264E−01 | −3.8263E−01 | 2.3415E−01 | −8.2920E−02 | 1.5747E−02 | 4.2409E−03 |
| S9 | −6.2577E−01 | 6.0818E−01 | −3.4876E−01 | 1.4823F−01 | −4.6396E−02 | 1.0010E−02 | −1.3783E−03 | 1.0804E−04 | −3.6542E−06 |
| S10 | −2.5482E−01 | 2.2124E−01 | −1.2693E−01 | 4.8525E−02 | −1.2269E−02 | 1.9506E−03 | −1.7894E−04 | 8.0195E−06 | −1.0852E−07 |

TABLE 15

| f1 | f2 | f3 | f4 | f5 | f | TTL | ImgH | FOV |
|---|---|---|---|---|---|---|---|---|
| (mm) | (mm) | (mm) | (mm) | (mm) | (mm) | (mm) | (min) | (°) |
| 3.19 | −9.32 | 153.60 | 3.81 | −2.46 | 3.81 | 4.34 | 3.38 | 81.3 |

FIG. 10A shows a longitudinal aberration curve of the optical lens group according to embodiment 5 to represent deviations of a convergence focal point after light of different wavelengths passes through the lens. FIG. 10B shows an astigmatism curve of the optical lens group according to embodiment 5 to represent a meridian image surface curvature and a sagittal image surface curvature. FIG. 10C shows a distortion curve of the optical lens group according to embodiment 5 to represent distortion values corresponding to different image heights. FIG. 10D shows a lateral color curve of the optical lens group according to embodiment 5 to represent deviations of different image heights on the imaging surface after the light passes through the lens. According to FIG. 10A to FIG. 10D, it can be seen that high imaging quality of the optical lens group provided in embodiment 5 may be achieved.

### Embodiment 6

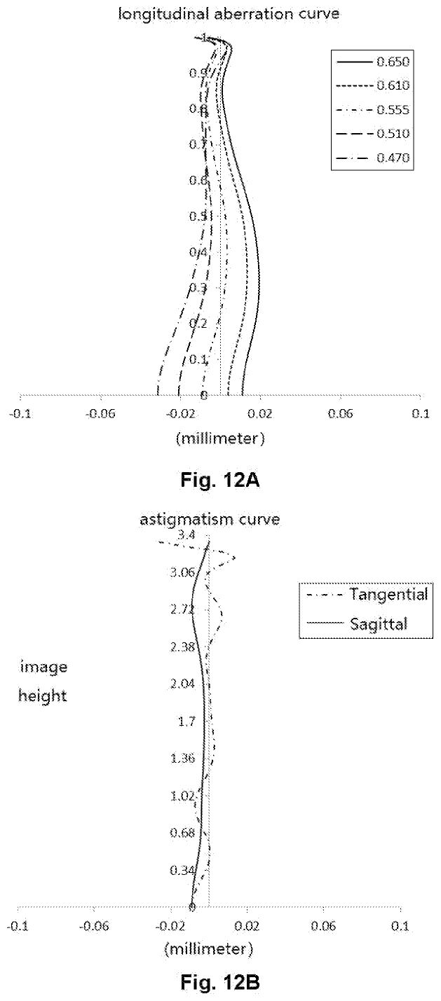

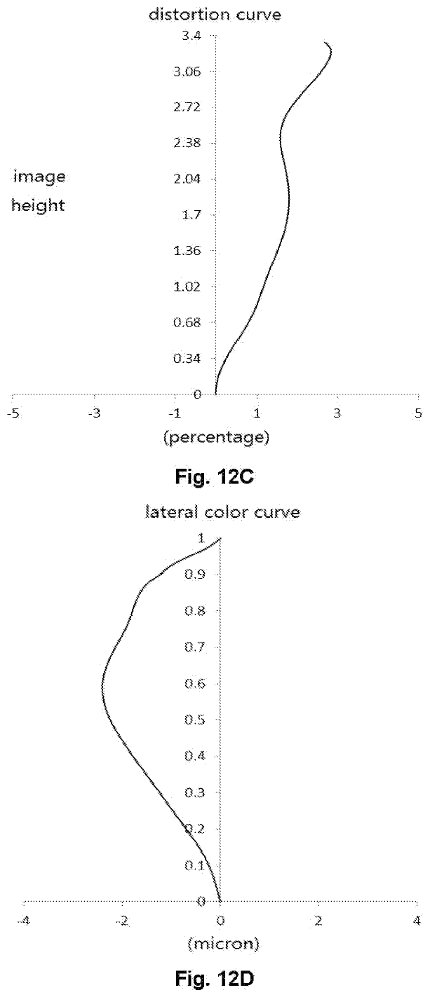

An optical lens group according to embodiment 6 of the disclosure will be described below with reference to FIG. 11 to FIG. 12D. FIG. 11 is a structure diagram of an optical lens group according to embodiment 6 of the disclosure.

As shown in FIG. 11, the optical lens group according to an exemplary implementation mode of the disclosure sequentially includes, from an object side to an image side along an optical axis, a diaphragm STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has positive refractive power, an object-side surface S5 thereof is a concave surface, and an image-side surface S6 is a convex surface. The fourth lens E4 has positive refractive power, an object-side surface S7 thereof is a concave surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 16 shows a surface type, curvature radius, thickness, material and cone coefficient of each lens of the optical lens group according to embodiment 6. Units of the curvature radius and the thickness are millimeter (mm). Table 17 shows high-order coefficients applied to each aspherical mirror surface in embodiment 6. A surface type of each aspherical surface may be defined by formula (1) given in embodiment 1. Table 18 shows effective focal lengths f1 to f5 of the lenses in embodiment 6, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 16

| | | | | Material | | Cone |
|---|---|---|---|---|---|---|
| Surface | Surface | Curvature | Thick- | Refractive | Abbe | coeffi- |
| number | type | radius | ness | index | number | cient |
| OBJ | Spherical | Infinite | Infinite | | | |
| STO | Spherical | Infinite | −0.3358 | | | |
| S1 | Aspherical | 1.3595 | 0.5985 | 1.55 | 56.1 | −0.1309 |
| S2 | Aspherical | 5.0922 | 0.0693 | | | −15.0329 |
| S3 | Aspherical | 5.2983 | 0.2500 | 1.67 | 20.4 | 34.7647 |
| S4 | Aspherical | 2.8453 | 0.3233 | | | 7.0210 |
| S5 | Aspherical | −6.5943 | 0.5799 | 1.55 | 56.1 | −99.0000 |
| S6 | Aspherical | −3.4124 | 0.4250 | | | −19.0694 |
| S7 | Aspherical | −12.9382 | 0.3700 | 1.55 | 56.1 | 99.0000 |
| S8 | Aspherical | −3.2483 | 0.4941 | | | −0.3222 |
| S9 | Aspherical | −390.6687 | 0.3915 | 1.54 | 55.7 | 99.0000 |
| S10 | Aspherical | 1.4960 | 0.2484 | | | −7.5718 |
| S11 | Spherical | Infinite | 0.2100 | 1.52 | 64.2 | |
| S12 | Spherical | Infinite | 0.3849 | | | |
| S13 | Spherical | Infinite | | | | |

TABLE 17

| Surface | | | | | | | | | |
|---|---|---|---|---|---|---|---|---|---|
| number | A4 | A6 | A8 | A10 | A12 | A14 | A16 | A18 | A20 |
| S1 | −2.5404E−04 | 8.8681E−02 | −5.8157E−01 | 2.4474E−00 | −6.4217E+00 | 1.0577E+01 | −1.0726E+01 | 6.1443E+00 | −1.5399E+00 |
| S2 | −1.7651E−01 | 1.9743E−01 | 1.5877E−01 | −8.3541E−01 | 1.0411E+00 | −1.6160E−01 | −1.2555E+00 | 1.5888E+00 | −6.9484E−01 |
| S3 | −2.6648E−01 | 3.7973E−01 | −3.5747E−01 | 2.8179E+00 | −1.5699E+01 | 4.3231E+01 | −6.6455E+01 | 5.4909E+01 | −1.9260E+01 |
| S4 | −1.0089E−01 | 3.1203E−01 | −1.1363E+00 | 1.0073E+01 | −5.0062E+01 | 1.4216E+02 | −2.3359E+02 | 2.0790E+02 | −7.7366E+01 |
| S5 | −1.7782E−01 | −9.9327E−02 | 8.9854E−01 | −4.9365E+00 | 1.8531E+01 | −4.7365E+01 | 7.6804E+01 | −7.0784E+01 | 2.8496E+01 |
| S6 | −1.8178E−01 | −2.7421E−01 | 1.6767E+00 | −5.8696E+00 | 1.2791E+01 | −1.7566E+01 | 1.4748E+01 | −6.9288E+00 | 1.4016E+00 |
| S7 | −7.7956E−02 | −9.6022E−03 | −5.3068E−01 | 1.6363E+00 | −2.5878E+00 | 2.4856E+00 | −1.4586E+00 | 4.7456E−01 | −6.4690E−02 |
| S8 | 1.2490E−02 | −2.3321E−02 | −1.5203E−01 | 3.7649E−01 | −3.6259E−01 | 1.8721E−01 | −5.4943E−02 | 8.6728E−03 | −5.7385E−04 |
| S9 | −3.9419E−01 | 2.9569E−01 | −1.2796E−01 | 4.1045E−02 | −1.0053E−02 | 1.7724E−03 | −2.0597E−04 | 1.3901E−05 | −4.0926E−07 |
| S10 | −2.1532E−01 | 1.6670E−01 | −9.0493E−02 | 3.3104E−02 | −8.1157E−03 | 1.2727E−03 | −1.1695E−04 | 5.3428E−06 | −7.7446E−08 |

TABLE 18

| f1 | f2 | f3 | f4 | f5 | f | TTL | ImgH | FOV |
|---|---|---|---|---|---|---|---|---|
| (mm) | (mm) | (mm) | (mm) | (mm) | (mm) | (mm) | (mm) | (°) |
| 3.22 | −9.62 | 12.17 | 7.84 | −2.78 | 3.81 | 4.34 | 3.38 | 80.5 |

FIG. 12A shows a longitudinal aberration curve of the optical lens group according to embodiment 6 to represent deviations of a convergence focal point after light of different wavelengths passes through the lens. FIG. 12B shows an astigmatism curve of the optical lens group according to embodiment 6 to represent a meridian image surface curvature and a sagittal image surface curvature. FIG. 12C shows a distortion curve of the optical lens group according to embodiment 6 to represent distortion values corresponding to different image heights. FIG. 12D shows a lateral color curve of the optical lens group according to embodiment 6 to represent deviations of different image heights on the imaging surface after the light passes through the lens. According to FIG. 12A to FIG. 12D, it can be seen that high imaging quality of the optical lens group provided in embodiment 6 may be achieved.

### Embodiment 7

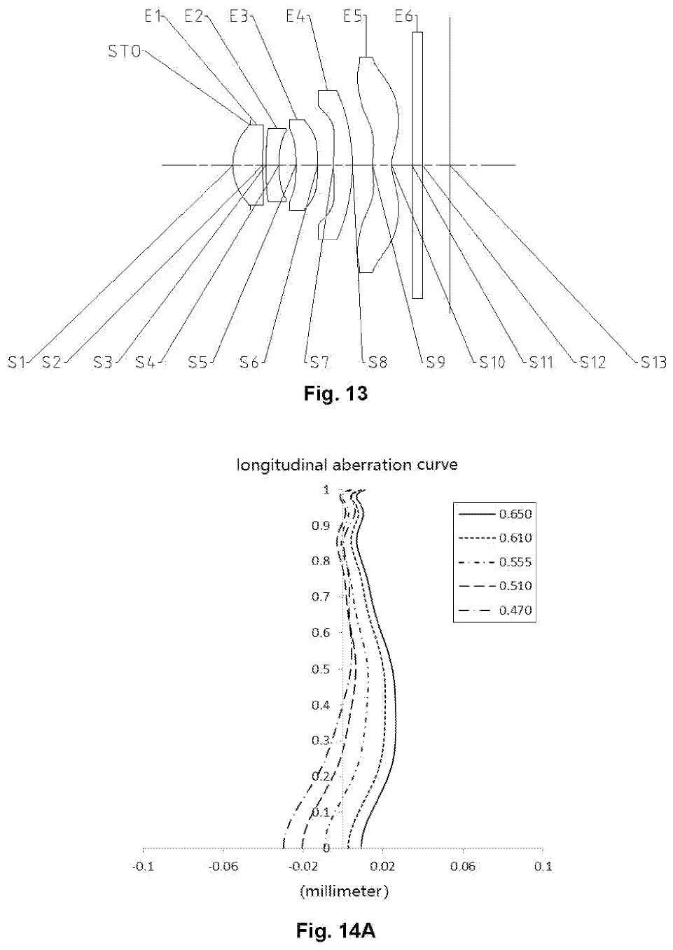

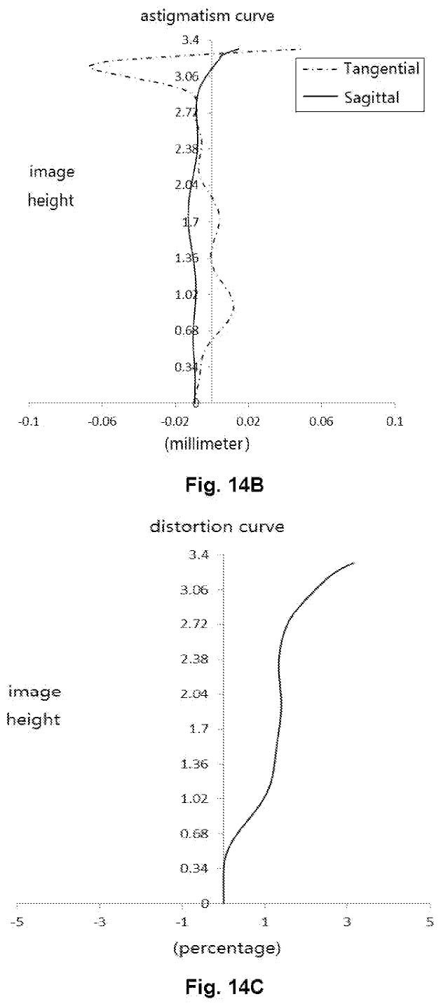

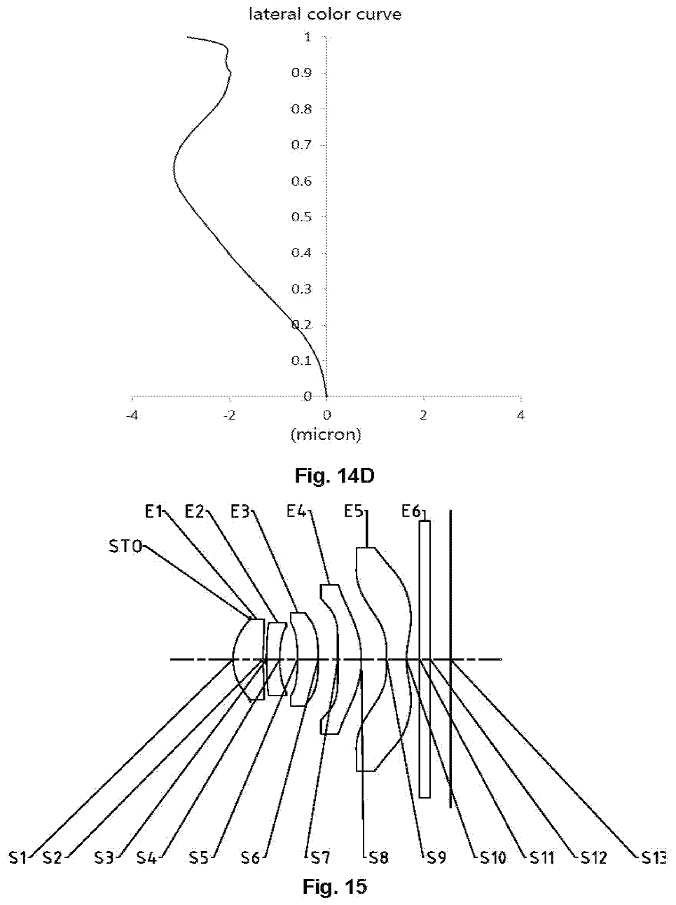

An optical lens group according to embodiment 7 of the disclosure will be described below with reference to FIG. 13 to FIG. 14D. FIG. 13 is a structure diagram of an optical lens group according to embodiment 7 of the disclosure.

As shown in FIG. 13, the optical lens group according to an exemplary implementation mode of the disclosure sequentially includes, from an object side to an image side along an optical axis, a diaphragm STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has negative refractive power, an object-side surface S5 thereof is a concave surface, and an image-side surface S6 is a convex surface. The fourth lens E4 has positive refractive power, an object-side surface S7 thereof is a convex surface, and an image-side surface S8 is a convex surface. The fifth lens E5 has negative refractive power, an object-side surface S9 thereof is a convex surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 19 shows a surface type, curvature radius, thickness, material and cone coefficient of each lens of the optical lens group according to embodiment 7. Units of the curvature radius and the thickness are millimeter (mm). Table 20 shows high-order coefficients applied to each aspherical mirror surface in embodiment 7. A surface type of each aspherical surface may be defined by formula (1) given in embodiment 1. Table 21 shows effective focal lengths f1 to f5 of the lenses in embodiment 7, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 19

| | | | | Material | | Cone |
|---|---|---|---|---|---|---|
| Surface | Surface | Curvature | Thick- | Refractive | Abbe | coeffi- |
| number | type | radius | ness | index | number | cient |
| OBJ | Spherical | Infinite | Infinite | | | |
| STO | Spherical | Infinite | −0.3300 | | | |
| S1 | Aspherical | 1.3535 | 0.5944 | 1.55 | 56.1 | −0.1737 |
| S2 | Aspherical | 5.0187 | 0.0672 | | | −18.4394 |
| S3 | Aspherical | 5.1997 | 0.2634 | 1.67 | 70.4 | 34.5804 |
| S4 | Aspherical | 2.7369 | 0.3406 | | | 6.9531 |
| S5 | Aspherical | −7.3720 | 0.4297 | 1.55 | 56.1 | −58.3727 |
| S6 | Aspherical | −12.3747 | 0.3204 | | | 8.7463 |
| S7 | Aspherical | 7.7801 | 0.3772 | 1.55 | 56.1 | −44.2153 |
| S8 | Aspherical | −4.4195 | 0.4002 | | | 0.9831 |
| S9 | Aspherical | 2.1566 | 0.3800 | 1.54 | 55.7 | −35.9295 |
| S10 | Aspherical | 1.0413 | 0.4128 | | | −8.1140 |
| S11 | Spherical | Infinite | 0.2100 | 1.52 | 64.2 | |
| S12 | Spherical | Infinite | 0.5492 | | | |
| S13 | Spherical | Infinite | | | | |

TABLE 20

| Surface | | | | | | | | | |
|---|---|---|---|---|---|---|---|---|---|
| number | A4 | A6 | A8 | A10 | A12 | A14 | A16 | A18 | A20 |
| S1 | −1.2420E−02 | 2.3226E−01 | −1.5213E+00 | 6.0923E+00 | −1.5333E+01 | 2.4348E+01 | −2.3775E401 | 1.3049E+01 | −3.1003E+00 |
| S2 | −1.6993E−01 | 6.7115E−02 | 1.1712E+00 | −5.5443E+00 | 1.5101E+01 | −2.7374E+01 | 3.1602E+01 | −2.0848E+01 | 5.9158E+00 |
| S3 | −2.5283E−01 | 3.3959E−01 | −4.8101E−01 | 5.5806E+00 | −3.0990E+01 | 8.6346E+01 | −1.3433E+02 | 1.1177E+02 | −3.9111E+01 |
| S4 | −1.1291E−01 | 5.9663E−01 | −3.9313E+00 | 2.5806E+01 | −1.0528E+02 | 2.6438E+02 | −4.0008E+02 | 3.3583E+02 | −1.2003E+02 |
| S5 | −2.4004E−01 | 1.6642E−01 | −1.0321E+00 | 4.7000E+00 | −1.2853E+01 | 1.8444E+01 | −9.0693E+00 | −6.4607E+00 | 7.2622E+00 |
| S6 | −2.1293E−01 | −1.8913E−01 | 1.0523E+00 | −3.7217E+00 | 8.3422E+00 | −1.1695E+01 | 9.9239E+00 | −4.6336E+00 | 9.2431E−01 |
| S7 | −1.3168E−02 | −1.4694E−01 | 2.8632E−01 | −7.6567E−01 | 1.1872E+00 | −1.0728E+00 | 5.5259E−01 | −1.4642E−01 | 1.5157E−02 |
| S8 | −5.1429E−02 | 2.7637E−01 | −5.3033E−01 | 5.8580E−01 | −4.0906E−01 | 1.8236E−01 | −5.0263E−02 | 7.8165E−03 | −5.2584E−04 |
| S9 | −3.9249E−01 | 2.3350E−01 | −2.4902E−02 | −3.0002E−02 | 1.6284E−02 | −3.9598E−03 | 5.3121E−04 | −3.8093E−05 | 1.1421E−06 |
| S10 | −1.7790E−01 | 8.5102E−02 | −1.6264E−02 | −5.2443E−03 | 4.0452E−03 | −1.0962E−03 | 1.5490E−04 | −1.1183E−05 | 3.2062E−07 |

TABLE 21

| f1 | f2 | f3 | f4 | f5 | f | TTL | ImgH | FOV |
|---|---|---|---|---|---|---|---|---|
| (mm) | (mm) | (mm) | (mm) | (mm) | (mm) | (mm) | (mm) | (°) |
| 3.21 | −9.07 | −34.45 | 5.22 | −4.26 | 3.81 | 4.35 | 3.38 | 80.1 |

FIG. 14A shows a longitudinal aberration curve of the optical lens group according to embodiment 7 to represent deviations of a convergence focal point after light of different wavelengths passes through the lens. FIG. 14B shows an astigmatism curve of the optical lens group according to embodiment 7 to represent a meridian image surface curvature and a sagittal image surface curvature. FIG. 14C shows a distortion curve of the optical lens group according to embodiment 7 to represent distortion values corresponding to different image heights. FIG. 14D shows a lateral color curve of the optical lens group according to embodiment 7 to represent deviations of different image heights on the imaging surface after the light passes through the lens. According to FIG. 14A to FIG. 14D, it can be seen that high imaging quality of the optical lens group provided in embodiment 7 may be achieved.

### Embodiment 8

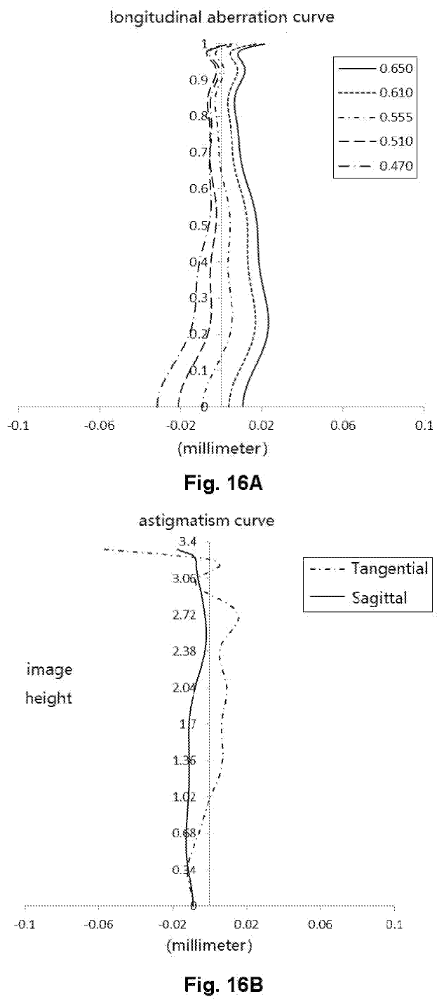

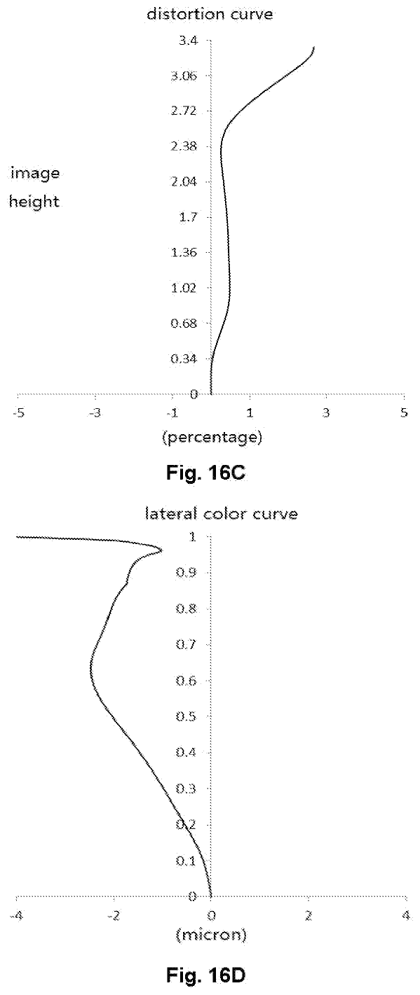

An optical lens group according to embodiment 8 of the disclosure will be described below with reference to FIG. 15 to FIG. 16D. FIG. 15 is a structure diagram of an optical lens group according to embodiment 8 of the disclosure.

As shown in FIG. 15, the optical lens group according to an exemplary implementation mode of the disclosure sequentially includes, from an object side to an image side along an optical axis, a diaphragm STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has negative refractive power, an object-side surface S5 thereof is a concave surface, and an image-side surface S6 is a convex surface. The fourth lens E4 has positive refractive power, an object-side surface S7 thereof is a convex surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 22 shows a surface type, curvature radius, thickness, material and cone coefficient of each lens of the optical lens group according to embodiment 8. Units of the curvature radius and the thickness are millimeter (mm). Table 23 shows high-order coefficients applied to each aspherical mirror surface in embodiment 8. A surface type of each aspherical surface may be defined by formula (1) given in embodiment 1. Table 24 shows effective focal lengths f1 to f5 of the lenses in embodiment 8, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 22

| | | | | Material | | Cone |
|---|---|---|---|---|---|---|
| Surface | Surface | Curvature | Thick- | Refractive | Abbe | coeffi- |
| number | type | radius | ness | index | number | cient |
| OBJ | Spherical | Infinite | Infinite | | | |
| STO | Spherical | Infinite | −0.3298 | | | |
| S1 | Aspherical | 1.3559 | 0.6021 | 1.55 | 56.1 | −0.1761 |
| S2 | Aspherical | 5.0260 | 0.0669 | | | −18.2426 |
| S3 | Aspherical | 5.1772 | 0.2642 | 1.67 | 20.4 | 34.9409 |
| S4 | Aspherical | 2.8157 | 0.3553 | | | 7.0801 |
| S5 | Aspherical | −9.2252 | 0.4114 | 1.55 | 56.1 | −61.4766 |
| S6 | Aspherical | −10.7453 | 0.3962 | | | 15.7687 |
| S7 | Aspherical | 40.6797 | 0.4705 | 1.55 | 56.1 | −99.0000 |
| S8 | Aspherical | −2.4256 | 0.5046 | | | −1.2280 |
| S9 | Aspherical | −29.9305 | 0.3918 | 1.54 | 55.7 | 64.9670 |
| S10 | Aspherical | 1.4934 | 0.2678 | | | −10.5923 |
| S11 | Spherical | Infinite | 0.2100 | 1.52 | 64.2 | |
| S12 | Spherical | Infinite | 0.4043 | | | |
| S13 | Spherical | Infinite | | | | |

TABLE 23

| Surface | | | | | | | | | |
|---|---|---|---|---|---|---|---|---|---|
| number | A4 | A6 | A8 | A10 | A12 | A14 | A16 | A18 | A20 |
| S1 | 2.0856E−04 | 1.0447E−01 | −8.1899E−01 | 3.7995E+00 | −1.0733E+01 | 1.8640E+01 | −1.9555E+01 | 1.1365E+01 | −2.8244E+00 |
| S2 | −1.8648E−01 | 3.2321E−01 | −6.3517E−01 | 1.9158E+00 | −4.4819E+00 | 5.5246E+00 | −2.4733E+00 | −1.0781E+00 | 1.0151E+00 |
| S3 | −2.7007E−01 | 6.5193E−01 | −2.9804E+00 | 1.7462E+01 | −6.7537E+01 | 1.5990E+02 | −2.2756E+02 | 1.7928E+02 | −6.0421E+01 |
| S4 | −5.3692E−02 | −4.4598E−01 | 6.6120E+00 | −3.7609E+01 | 1.3075E+02 | −2.3491E+02 | 3.7853E+02 | −2.7909E+02 | 8.7462E+01 |
| S5 | −1.8981E−01 | −3.2386E−01 | 2.9183E+00 | −1.5686E+01 | 5.2700E+01 | −1.1383E−02 | 1.5346E+02 | −1.1753E+02 | 3.9337E+01 |
| S6 | −1.8066E−01 | 7.7528E−03 | −1.7277E−01 | 9.2382E−01 | −2.7393E+00 | 4.6927E+00 | −4.6559E+00 | 2.5064E+00 | −5.5958E−01 |
| S7 | −3.0213E−02 | −1.4195E−01 | 2.4876E−01 | −3.5584E−01 | 3.0121E−01 | −1.3843E−01 | 2.1033E−02 | 7.8747E−03 | −2.6313E−03 |
| S8 | 2.0130E−02 | −8.7766E+02 | 1.7200E−01 | −1.9497E−01 | 1.4095E−01 | −6.3402E−02 | 1.7002E−02 | −2.4736E−03 | 1.4916E−04 |
| S9 | −4.5855E−01 | 3.7753E−01 | −1.7802E−01 | 6.0054E+02 | −1.4860E−02 | 2.5839E−03 | −2.9335E−04 | 1.9278E−05 | −5.5182E−07 |
| S10 | −2.0297E−01 | 1.4771E−01 | −7.5366E−02 | 2.6307E−02 | −6.2310E−03 | 9.4470E−04 | −8.2733E−05 | 3.4479E−06 | −3.7045E−08 |

TABLE 24

| f1 | f2 | f3 | f4 | f5 | f | TTL | ImgH | FOV |
|---|---|---|---|---|---|---|---|---|
| (mm) | (mm) | (mm) | (mm) | (mm) | (mm) | (mm) | (mm) | (°) |
| 3.21 | −9.71 | −132.06 | 4.21 | −2.64 | 3.81 | 4.35 | 3.38 | 80.4 |

FIG. 16A shows a longitudinal aberration curve of the optical lens group according to embodiment 8 to represent deviations of a convergence focal point after light of different wavelengths passes through the lens. FIG. 16B shows an astigmatism curve of the optical lens group according to embodiment 8 to represent a meridian image surface curvature and a sagittal image surface curvature. FIG. 16C shows a distortion curve of the optical lens group according to embodiment 8 to represent distortion values corresponding to different image heights. FIG. 16D shows a lateral color curve of the optical lens group according to embodiment 8 to represent deviations of different image heights on the imaging surface after the light passes through the lens. According to FIG. 16A to FIG. 16D, it can be seen that high imaging quality of the optical lens group provided in embodiment 8 may be achieved.

### Embodiment 9

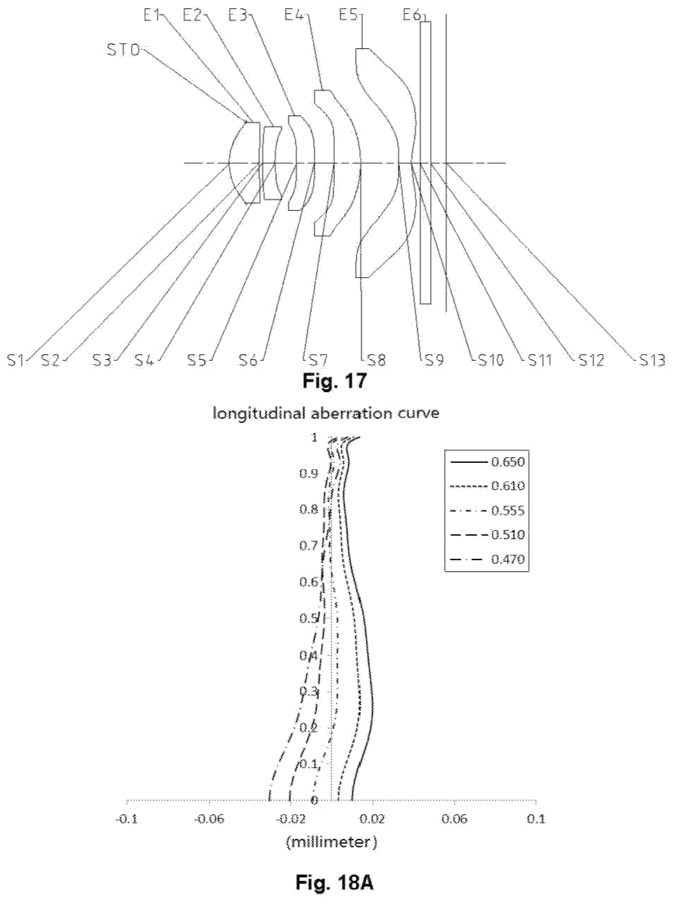

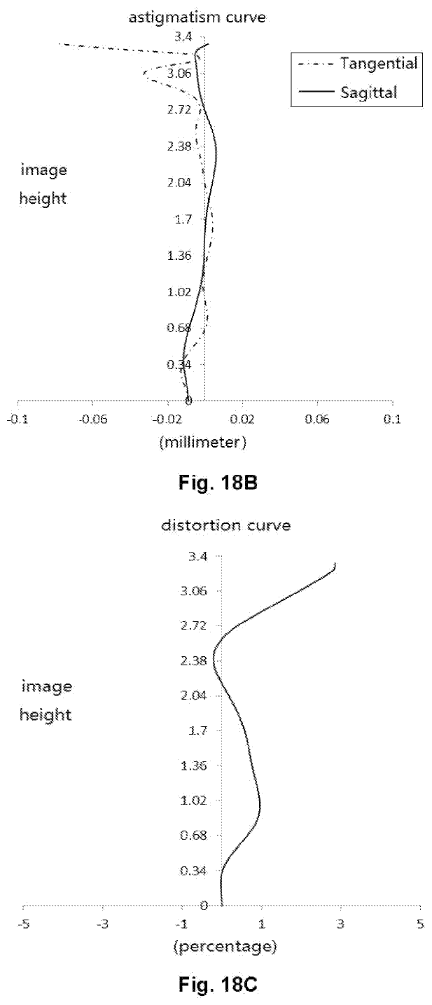

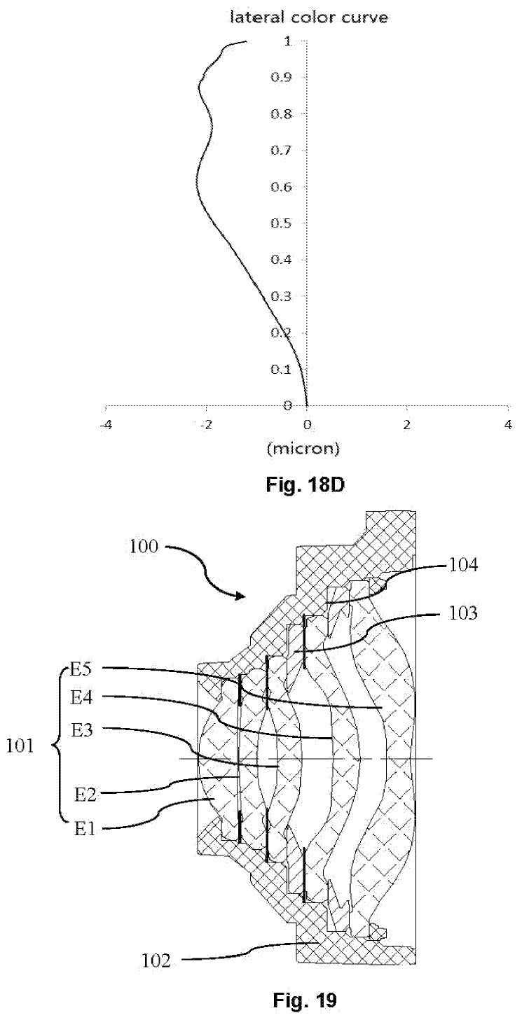

An optical lens group according to embodiment 9 of the disclosure will be described below with reference to FIG. 17 to FIG. 18D. FIG. 17 is a structure diagram of an optical lens group according to embodiment 9 of the disclosure.

As shown in FIG. 17, the optical lens group according to an exemplary implementation mode of the disclosure sequentially includes, from an object side to an image side along an optical axis, a diaphragm. STO, a first lens E1, a second lens E2, a third lens E3, a fourth lens E4, a fifth lens E5, an optical filter E6 and an imaging surface S13.

The first lens E1 has positive refractive power, an object-side surface S1 thereof is a convex surface, and an image-side surface S2 is a concave surface. The second lens E2 has negative refractive power, an object-side surface S3 thereof is a convex surface, and an image-side surface S4 is a concave surface. The third lens E3 has negative refractive power, an object-side surface S5 thereof is a concave surface, and an image-side surface S6 is a convex surface. The fourth lens E4 has positive refractive power, an object-side surface S7 thereof is a convex surface, and an image-side surface S8 is a convex surface. The fifth lens E5 has negative refractive power, an object-side surface S9 thereof is a concave surface, and an image-side surface S10 is a concave surface. The optical filter E6 has an object-side surface S11 and an image-side surface S12. Light from an object sequentially penetrates through each of the surfaces S1 to S12 and is finally imaged on the imaging surface S13.

Table 25 shows a surface type, curvature radius, thickness, material and cone coefficient of each lens of the optical lens group according to embodiment 9. Units of the curvature radius and the thickness are millimeter (mm). Table 26 shows high-order coefficients applied to each aspherical mirror surface in embodiment 9. A surface type of each aspherical surface may be defined by formula (1) given in embodiment 1. Table 26 shows effective focal lengths f1 to f5 of the lenses in embodiment 9, a total effective focal length f of the optical lens group, a distance TTL from the object-side surface S1 of the first lens E1 to the imaging surface S13 on the optical axis, ImgH (ImgH is a half of a diagonal length of an effective pixel region on the imaging surface S13) and a maximum field of view (FOV).

TABLE 25

| | | | | Material | | Cone |
|---|---|---|---|---|---|---|
| Surface | Surface | Curvature | Thick- | Refractive | Abbe | coeffi- |
| number | type | radius | ness | index | number | cient |
| OBJ | Spherical | Infinite | Infinite | | | |
| STO | Spherical | Infinite | −0.3254 | | | |
| S1 | Aspherical | 1.3626 | 0.5956 | 1.55 | 56.1 | −0.1637 |
| S2 | Aspherical | 5.1328 | 0.0670 | | | −17.2806 |
| S3 | Aspherical | 5.3213 | 0.2500 | 1.67 | 20.4 | 35.1319 |
| S4 | Aspherical | 2.8107 | 0.4337 | | | 7.1050 |
| S5 | Aspherical | −15.0674 | 0.3578 | 1.55 | 56.1 | 11.1891 |
| S6 | Aspherical | −49.0103 | 0.3932 | | | 99.0000 |
| S7 | Aspherical | 31.1615 | 0.5287 | 1.55 | 56.1 | 70.1268 |
| S8 | Aspherical | −2.5319 | 0.7646 | | | −0.1047 |
| S9 | Aspherical | −20.3072 | 0.2500 | 1.54 | 55.7 | 65.1219 |
| S10 | Aspherical | 1.5009 | 0.1789 | | | −12.3494 |
| S11 | Spherical | Infinite | 0.2100 | 1.52 | 64.2 | |
| S12 | Spherical | Infinite | 0.3154 | | | |
| S13 | Spherical | Infinite | | | | |

TABLE 26

| Surface | | | | | | | | | |
|---|---|---|---|---|---|---|---|---|---|
| number | A4 | A6 | A8 | A10 | A12 | A14 | A16 | A18 | A20 |
| S1 | −2.7635E−03 | 1.4510E−01 | 4.0182E+00 | 4.3693E+00 | −1.1710E+01 | 1.9627E+01 | −1.0082E+01 | 1.1456E+01 | −2.8070E+00 |
| S2 | −1.6450E−01 | 1.4235E−01 | 3.8755E−01 | −1.9386E+00 | 4.6487E+00 | −7.6336E+00 | 8.2240E+00 | −5.1494E+00 | 1.3894E+00 |
| S3 | −2.4074E−01 | 3.5490E−01 | −5.2350E−01 | 3.7630E+00 | −1.8351E+01 | 4.7908E+01 | −7.1421E+01 | 5.7722E+01 | 4.9816E+01 |
| S4 | −7.9543E−02 | 1.8708E−01 | 2.6609E−01 | −8.5736E−01 | −6.5813E−01 | 8.6475E+00 | −2.0404E−01 | 2.2158E+01 | −9.3795E+00 |
| S5 | −2.1980E−01 | 2.5565E−02 | 1.9886E−01 | −2.0214E+00 | 8.3488E+00 | −2.1206E+01 | 3.2435E+01 | −2.7296E+01 | 9.7833E+00 |
| S6 | −2.0279E−01 | −3.3487E−02 | 2.4024E−01 | −8.5516E−01 | 1.6307E+00 | −1.9121E+00 | 1.3785E+00 | −5.6706E−01 | 1.0867E−01 |
| S7 | −3.9861E−02 | −1.2380E−01 | 2.0905E−01 | −3.7932E−01 | 4.3296E−01 | −3.4413E−01 | 1.8244E−01 | −5.3379E−02 | 6.2693E−03 |
| S8 | 3.4975E−02 | −5.5263E−02 | 1.2042E−02 | 6.5486E−02 | −1.2512E−01 | 9.8844E−02 | −3.8764E−02 | 7.4930E−03 | −5.7247E−04 |
| S9 | −4.5452E−01 | 3.7469E−01 | −1.6726E−01 | 3.8577E−02 | −1.3377E−03 | −1.5289E−03 | 3.8051E−04 | −3.8330E−05 | 1.4749E−06 |
| S10 | −1.7032E−01 | 8.8498E−02 | −2.0308E−02 | −3.7823E−03 | 3.9671E−03 | −1.2274E−03 | 1.9820E−04 | −1.6563E−05 | 5.6153E−07 |

TABLE 27

| f1 | f2 | f3 | f4 | f5 | f | TTL | ImgH | FOV |
|---|---|---|---|---|---|---|---|---|
| (mm) | (mm) | (mm) | (mm) | (mm) | (mm) | (mm) | (mm) | (°) |
| 3.22 | −9.32 | −40.00 | 4.31 | −2.59 | 3.81 | 4.34 | 3.38 | 80.3 |

FIG. 18A shows a longitudinal aberration curve of the optical lens group according to embodiment 9 to represent deviations of a convergence focal point after light of different wavelengths passes through the lens. FIG. 18B shows an astigmatism curve of the optical lens group according to embodiment 9 to represent a meridian image surface curvature and a sagittal image surface curvature. FIG. 18C shows a distortion curve of the optical lens group according to embodiment 9 to represent distortion values corresponding to different image heights. FIG. 18D shows a lateral color curve of the optical lens group according to embodiment 9 to represent deviations of different image heights on the imaging surface after the light passes through the lens. According to FIG. 18A to FIG. 18D, it can be seen that high imaging quality of the optical lens group provided in embodiment 9 may be achieved.

From the above, embodiment 1 to embodiment 9 meet a relationship shown in Table 28 respectively.

TABLE 28

| | embodiment | | | | | | | | |
|---|---|---|---|---|---|---|---|---|---|
| conditional expression | 1 | 2 | 3 | 4 | 5 | 6 | 7 | 8 | 9 |
| FOV (°) | 82.0 | 80.9 | 82.6 | 80.9 | 81.3 | 80.5 | 80.1 | 80.4 | 80.3 |
| TTL/ImgH | 1.28 | 1.37 | 1.29 | 1.33 | 1.28 | 1.28 | 1.28 | 1.28 | 1.28 |
| DT52 − DT11 (mm) | 1.60 | 1.24 | 1.62 | 1.74 | 1.62 | 1.69 | 1.54 | 1.63 | 1.70 |
| CT3/ET3 | 1.54 | 1.13 | 1.33 | 1.36 | 1.31 | 1.78 | 1.49 | 1.47 | 1.57 |
| (f2 + f5)/f1 | −3.65 | −2.44 | −2.51 | −2.46 | −3.69 | −3.86 | −4.15 | −3.84 | −3.70 |
| CT4/NT4 | 1.46 | 1.56 | 1.44 | 1.44 | 2.33 | 1.09 | 1.26 | 1.36 | 1.27 |
| MT5/CT5 | 2.42 | 4.89 | 3.04 | 3.06 | 2.32 | 2.27 | 1.84 | 2.32 | 3.52 |

In each embodiment, at least one of mirror surfaces of the lenses is an aspherical mirror surface. An aspherical lens has a characteristic that a curvature keeps changing from a center of the lens to a periphery of the lens. Unlike a spherical lens with a constant curvature from a center of the lens to a periphery of the lens, an aspherical lens has a better curvature radius characteristic and the advantages of improving distortions and improving astigmatic aberrations. With adoption of the aspherical lens, the astigmatic aberrations during imaging may be eliminated as much as possible, thereby improving the imaging quality.

The optical lens group according to the implementation mode of the disclosure may adopt multiple lenses, for example, the abovementioned five lenses. Refractive power of each lens, a surface type, a center thickness of each lens, on-axis spaces between the lenses and the like may be reasonably configured to effectively reduce the size of the lens group, reduce the sensitivity of the lens group, improve the manufacturability of the lens group and ensure that the optical lens group is more favorable for production and machining and may be applied to an image camera lens with a small end portion size, described below in detail. In addition, the optical lens group configured as above may have the beneficial effects of ultra-small thickness, large image surface, high imaging quality and the like.

However, those skilled in the art should know that the number of the lenses forming the optical lens group may be changed without departing from the technical solutions claimed in the disclosure to achieve each result and advantage described in the specification. For example, although descriptions are made with five lenses as an example in the abovementioned embodiments, the optical lens group according to the disclosure is not limited to include five lenses. If necessary, the optical lens group may further include another number of lenses.

Another aspect of the disclosure also relates to an image camera lens with a small end portion size. The image camera lens according to the disclosure may include an optical lens group, a lens tube part and another shading element group. Herein, the optical lens group may be the five-lens optical lens group described above, and may also be any other optical lens group applicable to the image camera lens with a small end portion size.

The image camera lens according to the implementation mode of the disclosure will be described below with reference to FIG. 19 to FIG. 24 in detail.

FIG. 19 is a section view of an image camera lens 100 according to the disclosure. As shown in FIG. 19, the image camera lens 100 may include an optical lens group 101 and a lens tube 102 configured to accommodate and protect the optical lens group 101. The optical lens group 101 sequentially includes, from an object side to an image side along an optical axis, a first lens and at least one subsequent lens with refractive power. In an embodiment, the optical lens group 101 may include five lenses with refractive power, i.e., a first lens E1, a second lens E2, a third lens E3, a fourth lens E4 and a fifth lens E5. The five lenses are sequentially arranged from the object side to the image side along the optical axis.

According to an exemplary implementation mode, each of the first lens E1 to fifth lens E5 of the optical lens group 101 may have an optical effective region for optical imaging and optical noneffective regions extending outwards from two ends of the optical effective region. Generally, the optical effective region refers to a region, for optical imaging, of the lens, and the optical noneffective region refers to a structural region of the lens. In an assembling process of the optical lens group, each lens may be connected to the interior of the lens tube at the optical noneffective region of each lens in a connection manner such as dispensing adhesion such that the lens tube and the optical lens group form an integrated camera lens structure. In an imaging process of the image camera lens, the optical valid region of each lens may transmit light from an object to form an optical path to form a final optical image; and the optical noneffective region of each lens that is assembled is accommodated in the lens tube where no light may be transmitted, so that the optical noneffective regions do not directly participate in the imaging process of the image camera lens. It is to be noted that, for convenient description, each lens is divided into two parts, i.e., the optical effective region and the optical noneffective regions, for description in the disclosure. However, it is to be understood that the optical effective region and optical noneffective regions of the lens may be integrated rather than form two independent parts in a manufacturing process.

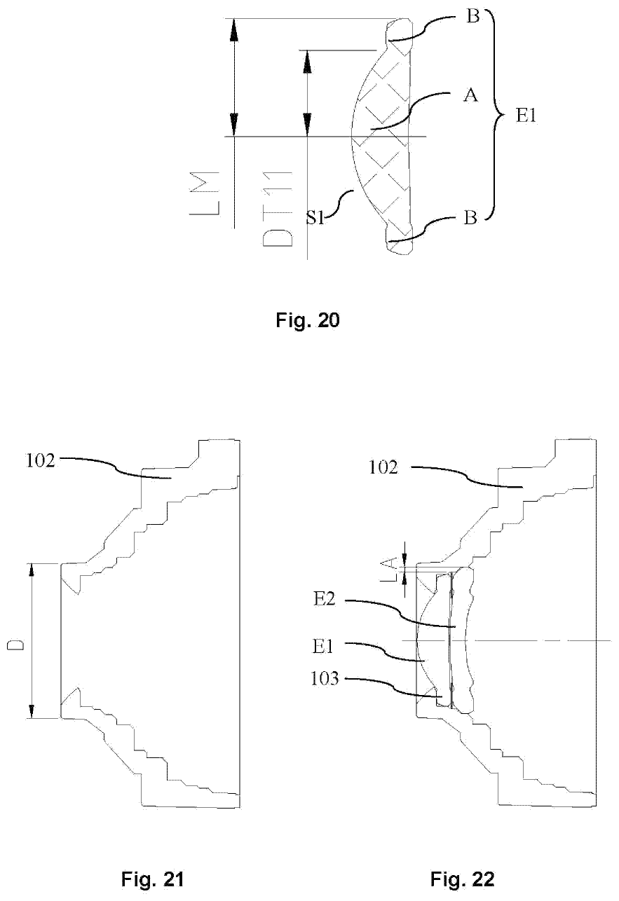

For example, for the first lens E1, FIG. 2 schematically shows an optical effective region A and an optical noneffective regions B of the first lens E1. As shown in FIG. 20, the first lens E1 includes the optical effective region A and the two optical noneffective regions B extending from two ends of the optical effective region A. It can be seen from FIG. 20 that a lens semi-diameter of the first lens E1 is LM and a maximum effective semi-diameter of an object-side surface S1 of the first lens E1 in the optical effective region A is DT11, so that a noneffective semi-diameter of the object-side surface S1 of the first lens E1 in the optical noneffective region B is LM−DT11.

According to the exemplary implementation mode, the noneffective semi-diameter LM−DT11 of the object-side surface of the first lens and a distance SAG11 from an intersection point of the object-side surface of the first lens and the optical axis to a vertex of the maximum effective semi-diameter of the object-side surface of the first lens may meet a conditional expression (LM−DT11)/SAG11<1.0. Such a configuration is favorable for achieving the characteristic of small end portion size of the image camera lens. In addition, in the exemplary implementation mode, the noneffective semi-diameter LM−DT11 of the object-side surface of the first lens and Sensize (Sensize is a diagonal size of a photosensitive chip on an imaging surface of the image camera lens, Sensize is twice of ImgH) may meet a conditional expression (LM−DT11)/Sensize<0.30. Meeting the conditional expression (LM−DT11)/Sensize<0.30 reflects the characteristic of large image surface of the image camera lens.

FIG. 21 schematically shows a front end semi-diameter D of a lens tube of an image camera lens according to the disclosure. According to the exemplary implementation mode, the front end semi-diameter D of the lens tube 102 of the image camera, of the disclosure and the maximum effective semi-diameter DT11 of the object-side surface S1 of the first lens E1 may meet a conditional expression DT11/D>0.63.

FIG. 22 schematically shows a semi-diameter difference LA between a first lens and second lens of an image camera lens according to the disclosure. According to the exemplary implementation mode, the semi-diameter difference LA of the first lens E1 and second lens E2 of the image camera lens of the disclosure may meet a conditional expression 0.1 mm≤LA≤0.5 mm.

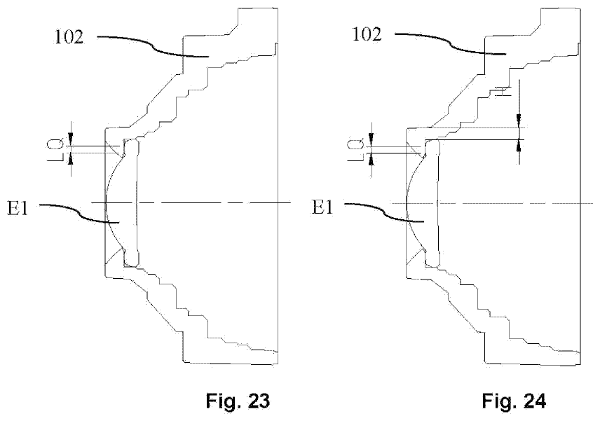

FIG. 23 schematically shows a supporting size LQ between a lens tube and first lens of an image camera lens according to the disclosure. According to the exemplary implementation mode, the supporting size LQ between the lens tube 102 and first lens E1 of the image camera lens of the disclosure may meet a conditional expression LQ≤0.13≤13 mm.

FIG. 24 schematically shows a front end wall thickness H of a lens tube of an image camera lens according to the disclosure. According to the exemplary implementation mode, the front end wall thickness H of the lens tube 102 of the image camera lens of the disclosure may meet a conditional expression H≤0.25 mm. The front end wall thickness H of the lens tube may be reasonably controlled to make it easier to obtain the image camera lens with a small-sized end portion.

According to the exemplary implementation mode, spacing rings may further be optionally arranged between adjacent lenses of the image camera lens of the disclosure to regulate axial positions between the lenses to avoid the lenses being squeezed and ensure uniform stresses on the lenses. For example, as shown in FIG. 22, a spacing ring 103 may be arranged between the first lens E1 and the second lens E2. The spacing ring 103 is ladderlike in a gear state of being separated from the second lens E2.

According to the exemplary implementation mode, the image camera lens of the disclosure may further include another shading element configured to assist in assembling and keep a system stable, for example, a gasket structure 104 shown in FIG. 19.

The image camera lens configured as above may have a lens tube end portion structure with a relatively small size and may meet an disclosure requirement of a front image camera lens of a portable electronic product such as a full-screen smart phone better.

The disclosure also provides a photographic device, of which an electronic photosensitive element may be a CCD or a CMOS. The photographic device may be an independent photographic device such as a digital camera, and may also be a photographic module integrated into a mobile electronic device such as a mobile phone. The photographic device is provided with the abovementioned image camera lens and/or optical lens group.

The above description is only description about the preferred embodiments of the disclosure and adopted technical principles. Those skilled in the art should know that the scope of disclosure involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An image camera lens, comprising an optical lens group and a lens tube configured to accommodate the optical lens group, wherein
the optical lens group sequentially comprises, from an object side to an image side along an optical axis, a first lens and at least one subsequent lens with refractive power, and
a lens semi-diameter LM of the first lens, a maximum effective semi-diameter DT11 of an object-side surface of the first lens and a distance SAG11 from an intersection point of the object-side surface of the first lens and the optical axis to a vertex of the maximum effective semi-diameter of the object-side surface of the first lens on the optical axis meet (LM−DT11)/SAG11<1.0.

2. The image camera lens as claimed in claim 1, wherein the maximum effective semi-diameter DT11 of the object-side surface of the first lens and a front end semi-diameter D of the lens tube meet DT11/D>0.63.

3. The image camera lens as claimed in claim 1, wherein Sensize is a diagonal size of a photosensitive chip on an imaging surface of the image camera lens, the lens semi-diameter LM of the first lens, the maximum effective semi-diameter DT11 of the object-side surface of the first lens and Sensize meet (LM−DT11)/Sensize<0.30.

4. The image camera lens as claimed in claim 1, wherein a supporting size LQ between the lens tube and the first lens meets LQ≤0.13 mm.

5. The image camera lens as claimed in claim 1, wherein a front end wall thickness H of the lens tube meets H≤0.25 mm.

6. The image camera lens as claimed in claim 1, wherein the first lens has positive refractive power, and an object-side surface thereof is a convex surface.

7. The image camera lens as claimed in claim 6, wherein the at least one subsequent lens comprises a second lens arranged between the first lens and the image side, the second lens has negative refractive power, an object-side surface thereof is a convex surface, and an image-side surface is a concave surface.

8. The image camera lens as claimed in claim 7, wherein a semi-diameter difference LA between the first lens and the second lens meets 0.1 mm≤LA≤0.5 mm.

9. The image camera lens as claimed in claim 7, wherein a ladderlike spacing ring is arranged between the first lens and the second lens.

10. The image camera lens as claimed in claim 7, wherein the at least one subsequent lens further comprises a third lens arranged between the second lens and the image side, and an image-side surface of the third lens is a convex surface.

11. The image camera lens as claimed in claim 10, wherein a center thickness CT3 of the third lens on the optical axis and an edge thickness ET3 of the third lens meet 1<CT3/ET3<2.

12. The image camera lens as claimed in claim 10, wherein the at least one subsequent lens further comprises a fourth lens and a fifth lens sequentially arranged between the third lens and the image side from the object side to the image side along the optical axis, the fourth lens has positive refractive power, an image-side surface thereof is a convex surface, and the fifth lens has negative refractive power.

13. The image camera lens as claimed in claim 12, wherein an effective focal length f1 of the first lens, an effective focal length f2 of the second lens and an effective focal length f5 of the fifth lens meet −4.2<(f2+f5)/f1<−2.

14. The image camera lens as claimed in claim 12, wherein the maximum effective semi-diameter DT11 of the object-side surface of the first lens and a maximum effective semi-diameter DT52 of an image-side surface of the fifth lens meet 1 mm<DT52−DT11<2 mm.

15. The image camera lens as claimed in claim 12, wherein a center thickness CT4 of the fourth lens on the optical axis and, a thickness NT4 of a thinnest part of the fourth lens meet 1<CT4/NT4<3.

16. The image camera lens as claimed in claim 15, wherein a thickness MT5 of a thickest part of the fifth lens and a center thickness CT5 of the fifth lens on the optical axis meet 1<MT5/CT5<5.

17. The image camera lens as claimed in claim 6, wherein ImgH is a diagonal length of an effective pixel region on the imaging surface of the image camera lens, a distance TTL from the object-side surface of the first lens to the imaging surface of the image camera lens on the optical axis and ImgH meet TTL/ImgH≤1.4.

18. The image camera lens as claimed in claim 1, wherein a maximum field of view (FOV) of the image camera lens meets FOV<85°.

19. The image camera lens as claimed in claim 2, wherein a maximum field of view (FOV) of the image camera lens meets FOV<85°.

20. The image camera lens as claimed in claim 3, wherein a maximum field of view (FOV) of the image camera lens meets FOV<85°.
